(19) United States
(12) Patent Application Publication
(10) Pub. No.: US 2025/0372108 A1
(43) Pub. Date: Dec. 4, 2025

(54) METHOD AND APPARATUS FOR SWITCHING BETWEEN LOSSY CODEC AND LOSSLESS CODEC

(71) Applicant: HUAWEI TECHNOLOGIES CO., LTD., Shenzhen (CN)

(72) Inventors: Chunhui Du, Shenzhen (CN); Fan Fan, Shenzhen (CN); Zhuo Wang, Shenzhen (CN); Bin Feng, Shenzhen (CN); Jinghao Luo, Shenzhen (CN)

(73) Assignee: HUAWEI TECHNOLOGIES CO., LTD., Shenzhen (CN)

(21) Appl. No.: 19/297,374

(22) Filed: Aug. 12, 2025

Related U.S. Application Data
(63) Continuation of application No. PCT/CN2024/073429, filed on Jan. 22, 2024.

(30) Foreign Application Priority Data
Feb. 17, 2023 (CN) 202310152315.7

(51) Int. Cl. G10L 19/02; G10L 19/032

(52) U.S. Cl. CPC G10L 19/0212; G10L 19/032

(57) ABSTRACT

A method and an apparatus for switching between a lossy codec and a lossless codec are provided. The method includes: obtaining a waveform of a previous frame Ti−1, and updating the waveform of the previous frame Ti−1 to an input frame buffer in the lossless codec, where the waveform of the previous frame Ti−1 is encoded by a lossy encoder; performing integer window time domain aliasing cancellation INT winTDAC on a waveform in a lossless encoder buffer to obtain a first transform result, and updating the first transform result to an overlapped buffer in the lossless codec; obtaining a waveform of a current frame Ti, and updating the waveform of the current frame Ti to the input frame buffer; and performing integer modified discrete cosine transform INTMDCT on the waveform in the lossless encoder buffer to obtain a second transform result.

### CROSS-REFERENCE TO RELATED APPLICATIONS

This application is a continuation of International Application No. PCT/CN2024/073429, filed on Jan. 22, 2024, which claims priority to Chinese Patent Application No. 202310152315.7, filed on Feb. 17, 2023. The disclosures of the aforementioned applications are hereby incorporated by reference in their entireties.

### TECHNICAL FIELD

This application relates to the field of audio coding technologies, and in particular, to a method and an apparatus for switching between a lossy codec and a lossless codec.

### BACKGROUND

As wireless Bluetooth devices such as true wireless stereo (TWS) headsets, smart speakers, and smartwatches are widely popularized and used in daily life, requirements of users for high-quality music playing experience in various scenarios become increasingly urgent, especially in environments in which Bluetooth signals are vulnerable to interference, for example, subways, airports, and railway stations. Due to a limitation of a Bluetooth channel on a data transmission size, a music data stream needs to experience data compression by an audio encoder at a transmit end of a Bluetooth device before being transmitted to a receive end of the Bluetooth device for decoding. This transmission limitation therefore promotes booming development of various lossy Bluetooth audio codecs.

Currently, mainstream lossy Bluetooth coding include default subband coding (SBC) of the Bluetooth advanced audio distribution profile (A2DP), Bluetooth advanced audio coding (AAC) series (such as AAC-LC, AAC-LD, AAC-HE, and AAC-HEv2) of the moving picture experts group (MPEG), Qualcomm aptX series (aptX, aptX HD, and aptX low latency), and the like. Lossless audio coding is mainly implemented through linear predictive coding (LPC), such as free lossless audio codec (FLAC) and Apple lossless audio codec (ALAC). In addition, a few organizations implement lossless audio coding through integer modified discrete cosine transform (INTMDCT).

During real-time communication, because a channel is usually interfered and fluctuates, it is necessary to switch from lossless audio coding to lossy audio coding when channel quality is degraded, or switch from lossy audio coding to lossless audio coding when channel quality becomes better.

However, in a solution for switching between a lossy codec and a lossless codec in a conventional technology, the lossy codec and the lossless codec are a frequency domain codec and a time domain codec. Therefore, during switching between the lossy codec and the lossless codec, a modified discrete cosine transform/inverse modified discrete cosine transform (MDCT/IMDCT) transform pair is first required to obtain a windowed overlapped signal, and then time-frequency domain transform is performed. An entire switching process is complex, switching cannot be implemented in real time without awareness, and overheads are high. In addition, currently there are few scenarios of switching between lossy audio coding and lossless audio coding in commercial applications.

### SUMMARY

Embodiments of this application provide a method and an apparatus for switching between a lossy codec and a lossless codec, so that switching between the lossy codec and the lossless codec can be implemented in real time without awareness, overheads are low, and no perceived noise is introduced.

According to a first aspect, this application provides a method for switching from a lossy encoder to a lossless encoder. A lossless encoder buffer (buffer) includes an overlapped buffer and an input frame buffer. The overlapped buffer is configured to store an aliased waveform, and the input frame buffer is configured to store a non-aliased waveform. The method includes: obtaining a waveform of a previous frame Tᵢ₋₁, and updating the waveform of the previous frame Tᵢ₋₁ to the input frame buffer, where the waveform of the previous frame Tᵢ₋₁ is encoded by the lossy encoder; performing integer window time domain aliasing cancellation INT winTDAC on the waveform in the lossless encoder buffer to obtain a first transform result, and updating the first transform result to the overlapped buffer; obtaining a waveform of a current frame Tᵢ, and updating the waveform of the current frame Tᵢ to the input frame buffer; and performing integer modified discrete cosine transform INTMDCT on the waveform in the lossless encoder buffer to obtain a second transform result.

The waveform of the previous frame Tᵢ₋₁ is obtained from a lossy encoder buffer (buffer).

The waveform of the current frame Tᵢ is obtained from pulse-code modulation PCM audio data.

The lossy encoder implements time-frequency domain transform through MDCT, and the lossless encoder implements time-frequency domain transform through INTMDCT. That is, the lossy encoder and the lossless encoder are both frequency domain codecs.

From a perspective of technical effects, in a process of switching from the lossy encoder to the lossless encoder, because historical waveform data is in the overlapped buffer of the lossless encoder, and the historical waveform data does not match the current frame Tᵢ (that is, the historical waveform data cannot be used for an INTMDCT process of the waveform of the current frame Tᵢ), the waveform of the previous frame Tᵢ₋₁ may be obtained from the lossy encoder buffer, and INT winTDAC is performed, to obtain an aliased waveform that matches the current frame Tᵢ, so that correct transform from time domain to frequency domain (namely, INTMDCT transform) is performed on the waveform of the current frame Tᵢ. However, in a conventional technology, a lossy codec and a lossless codec are respectively a frequency domain codec and a time domain codec, and the codecs are of different types. Therefore, in the conventional technology, in a process of switching from lossy encoding to lossless encoding, time-frequency domain transform needs to be first performed on data obtained from a lossy encoder buffer. Compared with an INT winTDAC process in this application, this process is complex and has high overheads. That is, this application is different from the conventional technology in that switching from the lossy encoder to the lossless encoder can be implemented conveniently and quickly, and the switching process is implemented in real time without awareness.

In an embodiment, the method further includes: initializing the overlapped buffer before INT winTDAC is performed on the waveform in the lossless encoder buffer.

From the perspective of technical effects, in this application, historical data in the overlapped buffer is initialized first before INT winTDAC is performed on the waveform of the previous frame Tᵢ₋₁, so that impact of the data in the overlapped buffer on an INT winTDAC process can be effectively avoided.

In an embodiment, both the waveform of the previous frame Tᵢ₋₁ and the waveform of the current frame Tᵢ include N non-aliased data points in time domain, and N is a positive integer; the first transform result includes N/2 aliased data points in time domain; and the second transform result includes N/2 aliased data points in time domain and N data points in frequency domain.

The N/2 aliased data points in time domain in the second transform result are an overlapped frame of the current frame, and are used in an INTMDCT process of a next frame Tᵢ₋₁.

From the perspective of technical effects, after INT winTDAC is performed, the aliased waveform that matches the current frame Tᵢ may be obtained, so that a correct second transform result is obtained after INTMDCT is performed.

In an embodiment, the method further includes: updating, to the overlapped buffer, the N/2 aliased data points in time domain in the second transform result.

From the technical effect perspective, the N/2 aliased data points in time domain in the second transform result are used for the INTMDCT process of the waveform of the next frame Tᵢ₊₁. Therefore, after the N/2 data points are updated to the overlapped buffer, when lossless encoding is performed on the next frame Tᵢ₊₁, after a waveform of the next frame Tᵢ₋₁ is copied to the input frame buffer, INTMDCT may be directly performed. That is, in a process of lossless encoding for the waveform of the next frame Tᵢ₊₁, interaction with the lossy encoder is not required, and switching to lossless encoder has been successfully implemented.

In an embodiment, the method further includes: quantizing and encoding the N data points in frequency domain in the second transform result to obtain an encoded bitstream corresponding to the current frame Tᵢ.

From the perspective of technical effects, after transform from time domain to frequency domain for the current frame is implemented, frequency domain data is directly quantized and encoded, so that the encoded bitstream corresponding to the current frame Tᵢ can be obtained, and a process is simple.

According to a second aspect, this application provides a method for switching from a lossless encoder to a lossy encoder. A lossy encoder buffer includes a previous frame buffer and a current frame buffer. The previous frame buffer is configured to store a waveform of a previous frame Tᵢ₋₁, and the current frame buffer is configured to store a waveform of a current frame Tᵢ. The method includes: obtaining the waveform of the previous frame Tᵢ₋₁, and updating the waveform of the previous frame Tᵢ₋₁ to the previous frame buffer, where the waveform of the previous frame Tᵢ₋₁ is encoded by the lossless encoder; obtaining a waveform of a current frame Tᵢ, and updating the waveform of the current frame Tᵢ to the current frame buffer; and performing modified discrete cosine transform MDCT on the waveform in the lossy encoder buffer to obtain a third transform result.

The waveform of the previous frame Tᵢ₋₁ is obtained from a lossless encoder buffer (buffer).

The waveform of the current frame Tᵢ is obtained from pulse-code modulation PCM audio data.

The lossy encoder implements time-frequency domain transform through MDCT, and the lossless encoder implements time-frequency domain transform through INTMDCT. That is, the lossy encoder and the lossless encoder are both frequency domain codecs.

From a perspective of technical effects, in a process of switching from the lossless encoder to the lossy encoder, because in the previous frame buffer of the lossy encoder is historical waveform data, and the historical waveform data does not match the current frame Tᵢ, the waveform of the previous frame Tᵢ₋₁ may be obtained from the lossless encoder buffer, and then MDCT is directly performed, so that correct transform from time domain to frequency domain can be performed on the waveform of the current frame Tᵢ. In a conventional technology, a lossy encoder and a lossless encoder are respectively a frequency domain encoder and a time domain encoder, where the lossy encoder and the lossless encoder are of different types. Therefore, in the conventional technology, in a process of switching from lossy encoding to lossless encoding, time-frequency domain transform needs to be first performed on data obtained from a lossy encoder buffer. This application is different from the conventional technology in that the lossless encoder and the lossy encoder are both frequency domain encoders, and data type conversion is not required. After the waveform of the previous frame is obtained, transform from time domain to frequency domain (namely, MDCT) may be directly performed. The entire process is excessively convenient and simple, overheads are low, and the switching process is implemented in real time without awareness.

In an embodiment, both the waveform of the previous frame Tᵢ₋₁ and the waveform of the current frame Tᵢ include N non-aliased data points in time domain, and Nis a positive integer; and the third transform result includes N data points in frequency domain.

From the perspective of technical effects, after the waveform of the previous frame Tᵢ₋₁ is updated to the previous frame buffer, MDCT transform is performed, so that the waveform of the current frame Tᵢ can be smoothly transformed into a spectrum of the current frame Tᵢ.

In an embodiment, the method further includes: quantizing and encoding the third transform result to obtain an encoded bitstream corresponding to the current frame Tᵢ.

From the perspective of technical effects, after transform from time domain to frequency domain for the current frame is implemented, frequency domain data is directly quantized and encoded, so that the encoded bitstream corresponding to the current frame Tᵢ can be obtained, and a process is simple.

According to a third aspect, this application provides a method for switching from a lossy decoder to a lossless decoder. A lossless decoder buffer includes an overlapped buffer and an input frame buffer. The overlapped buffer is configured to store waveform data, and the input frame buffer is configured to store spectral data. The method includes: obtaining a spectrum of a current frame Tᵢ, and updating the spectrum of the current frame Tᵢ to the input frame buffer; performing integer inverse modified discrete cosine transform INTIMDCT on a spectrum in the lossless decoder buffer to obtain a fourth transform result; and obtaining an overlapped frame of a previous frame Tᵢ₋₁, and performing overlap-add OLA on the overlapped frame of the previous frame Tᵢ₋₁ and a non-aliased waveform in the fourth transform result to obtain a waveform of the current frame Tᵢ, where the spectrum of the previous frame Tᵢ₋₁ is decoded by the lossy decoder.

The overlapped frame of the previous frame Tᵢ₋₁ is obtained from the lossy decoder buffer (buffer).

The spectrum of the current frame Tᵢ is obtained based on a received encoded bitstream.

The lossy decoder implements time-frequency domain transform through IMDCT, and the lossless decoder implements time-frequency domain transform through INTIMDCT. That is, the lossy decoder and the lossless decoder are both frequency domain codecs.

From a perspective of technical effects, in a process of switching from the lossy decoder to the lossless decoder, in the overlapped buffer of the lossless decoder is historical waveform data, and the historical waveform data cannot be used for an INTIMDCT process of the spectrum of the current frame Tᵢ. That is, the INTIMDCT process of the current frame Tᵢ lacks some data. As a result, the non-aliased waveform in the fourth transform result obtained through transform lacks an overlap-add OLA process. However, the lossy decoder buffer exactly stores data used for OLA (the overlapped frame of the previous frame Tᵢ₋₁). In this case, the data may be directly obtained to perform overlap-add, so that the waveform of the current frame Tᵢ can be obtained, and transform from frequency domain to time domain is implemented. It can be seen that in a conventional technology, a lossy decoder and a lossless decoder are respectively a frequency domain decoder and a time domain decoder, and data types in a lossy decoder buffer and a lossless decoder buffer are different (frequency domain data and time domain data respectively). Therefore, in the conventional technology, in a process of switching from the lossy decoder to the lossless decoder, time-frequency domain transform needs to be performed on data obtained from the lossy decoder buffer. In this application, the lossy decoder and the lossless decoder are both frequency domain decoders (that is, an architecture of this application is completely different from that of the conventional technology), such a process is not required, and data is directly obtained to perform overlap-add OLA. In this way, switching to the lossless decoder can be implemented smoothly. Therefore, this application is different from the conventional technology in that the switching process is simple, overheads are low, and the switching process is implemented in real time without awareness.

In an embodiment, the method further includes: initializing the overlapped buffer before integer inverse modified discrete cosine transform INTIMDCT is performed on the spectrum in the lossless decoder buffer.

From a technical effect perspective, historical data is initialized, so that impact of data in the next frame buffer on an INT IMDCT process can be effectively avoided.

In an embodiment, the spectrum of the current frame Tᵢ includes N data points in frequency domain, and N is a positive integer; and the non-aliased waveform in the fourth transform result includes N non-aliased data points in time domain.

In an embodiment, the fourth transform result further includes N/2 aliased data points in time domain. The method further includes: updating, to the overlapped buffer, the N/2 aliased data points in time domain.

From the perspective of technical effects, the N/2 aliased data points in time domain are data that needs to be used in an INTIMDCT process of a next frame. Updating the data to the overlapped buffer can ensure smooth decoding of a spectrum of the next frame Tᵢ₊₁. That is, starting from the next frame Tᵢ₊₁, a decoding process is completely completed by the lossless decoder, and interaction with the lossy decoder is not required.

In an embodiment, obtaining the spectrum of the current frame Tᵢ includes: The lossless decoder performs decoding and dequantization processing on the received encoded bitstream, and obtains the spectrum of the current frame Tᵢ from a processing result.

From the perspective of technical effects, before the lossless decoder performs transform from the spectrum to time domain, decoding and dequantization need to be performed on the received encoded bitstream, to ensure that correct spectral data is used in the INTIMDCT process.

According to a fourth aspect, this application provides a method for switching from a lossless decoder to a lossy decoder. A lossy decoder buffer includes a current frame buffer, and the current frame buffer is configured to store spectral data. The method includes: obtaining a spectrum of a current frame Tᵢ, and updating the spectrum of the current frame Tᵢ to the current frame buffer; performing inverse modified discrete cosine transform IMDCT on the data in the lossy decoder buffer to obtain a fifth transform result; performing inverse integer window time domain aliasing cancellation Inverse INT winTDAC on an overlapped frame of a previous frame Tᵢ₋₁ in a lossless decoder buffer to obtain a sixth transform result, where a spectrum of the previous frame Tᵢ₋₁ is decoded by the lossless decoder; and performing overlap-add OLA on a non-aliased waveform in the sixth transform result and a corresponding waveform in the fifth transform result to obtain a waveform of the current frame Tᵢ.

The spectrum of the current frame Tᵢ is obtained based on a received encoded bitstream.

The lossy decoder implements time-frequency domain transform through IMDCT, and the lossless decoder implements time-frequency domain transform through INTIMDCT. That is, the lossy decoder and the lossless decoder are both frequency domain codecs.

From a perspective of technical effects, in a process of switching from the lossless decoder to the lossy decoder, in a next frame buffer of the lossy decoder is historical waveform data, and the historical waveform data cannot be used for an IMDCT process of the spectrum of the current frame Tᵢ. That is, the IMDCT process of the current frame Tᵢ lacks some data. As a result, the non-aliased waveform in the fifth transform result obtained through transform is not the required waveform of the current frame Tᵢ. However, the lossless decoder buffer exactly stores the overlapped frame the previous frame Tᵢ₋₁. Expansion and window removal processing (Inverse INT winTDAC) is performed on the overlapped frame of the previous frame Tᵢ₋₁, so that historical data required for performing the IMDCT process on the spectrum of the current frame Tᵢ can be obtained. Finally, overlap-add OLA is performed, so that a correct waveform of the current frame Tᵢ can be obtained, and transform from frequency domain to time domain is implemented. In a conventional technology, a lossy decoder and a lossless decoder are respectively a frequency domain decoder and a time domain decoder, and data types in a lossy decoder buffer and a lossless decoder buffer are different (frequency domain data and time domain data respectively). Therefore, in the conventional technology, in a process of switching from the lossless decoder to the lossy decoder, time-frequency domain transform needs to be performed on data obtained from the lossy decoder buffer. In this application, the lossy decoder and the lossless decoder are both frequency domain decoders (that is, an architecture of this application is completely different from that of the conventional technology), such a process is not required, and only a simple Inverse INT winTDAC process and an overlap-add OLA process are required. In this way, switching to the lossy decoder can be implemented smoothly. Therefore, this application is different from the conventional technology in that the switching process is simple, overheads are low, and the switching process is implemented in real time without awareness.

In an embodiment, the lossy decoder buffer further includes a next frame buffer, and the next frame buffer is configured to store waveform data. The method further includes: updating an overlapped frame of the current frame Tᵢ in the fifth transform result to the next frame buffer.

From the perspective of technical effects, because the overlapped frame of the current frame Tᵢ is data required for decoding a spectrum of a next frame Tᵢ₊₁, updating the overlapped frame of the current frame Tᵢ to the next frame buffer can ensure smooth decoding of the spectrum of the next frame Tᵢ₊₁. That is, starting from the next frame Tᵢ₊₁, a decoding process is completely done by the lossless decoder, and interaction with the lossy decoder is not required.

The fifth transform result includes the overlapped frame of the current frame Tᵢ and a time domain non-aliased waveform corresponding to the current frame Tᵢ. The time domain non-aliased waveform corresponding to the current frame Tᵢ corresponds to the non-aliased waveform in the sixth transform result.

From the perspective of technical effects, the non-aliased waveform in the sixth transform result is data required for performing the IMDCT process on the spectrum of the current frame Tᵢ. After the non-aliased waveform is restored, OLA is performed on the non-aliased waveform and the time domain non-aliased waveform corresponding to the current frame, so that a correct waveform of the current frame Tᵢ can be restored, and switching to the lossy decoder is implemented.

In an embodiment, the method further includes: initializing the next frame buffer before inverse modified discrete cosine transform IMDCT is performed on the data in the lossy decoder buffer.

From the perspective of technical effects, data in the next frame buffer is initialized, so that impact of the data in the next frame buffer on the IMDCT process can be effectively avoided.

In an embodiment, the method further includes: initializing an input frame buffer in the lossless decoder buffer before inverse integer window time domain aliasing cancellation Inverse INT winTDAC is performed on the overlapped frame of the previous frame Tᵢ₋₁ in the lossless decoder buffer, where the input frame buffer is configured to store spectral data.

From the perspective of technical effects, the data in the input frame buffer is initialized, so that impact of the data in the input frame buffer on the Inverse INT winTDAC process can be effectively avoided.

In an embodiment, obtaining the spectrum of the current frame Tᵢ includes: The lossy decoder performs decoding and dequantization processing on the received encoded bitstream, and obtains the spectrum of the current frame Tᵢ from a processing result.

From the perspective of technical effects, decoding and dequantization are performed on the received encoded bitstream, to ensure that correct spectral data is used in the IMDCT process.

In conclusion, the foregoing four methods provided in the first aspect to the fourth aspect are essentially implemented based on a data type difference in buffers of a frequency domain lossy codec and a frequency domain lossless codec and a corresponding transform mechanism. Because the frequency domain lossy codec and the frequency domain lossless codec are both frequency domain codecs, in a process of switching to one side, time-frequency domain transform may be performed only after simple processing is performed on data obtained from a peer side. This is different from the conventional technology in that an implementation process is simple, an operation is convenient, and a switching process is implemented without awareness.

According to a fifth aspect, this application provides an encoding apparatus. The encoding apparatus includes a lossless encoder. Storage units on the lossless encoder include a first storage unit and a second storage unit. The first storage unit is configured to store an aliased waveform, and the second storage unit is configured to store a non-aliased waveform. The encoding apparatus further includes: an obtaining unit, configured to: obtain a waveform of a previous frame Tᵢ₋₁, and update the waveform of the previous frame Tᵢ₋₁ to the second storage unit, where the waveform of the previous frame Tᵢ₋₁ is encoded by a lossy encoder in the encoding apparatus; and a processing unit, configured to: perform integer window time domain aliasing cancellation INT winTDAC on the waveform in the storage unit on the lossless encoder to obtain a first transform result, and update the first transform result to the first storage unit. The obtaining unit is further configured to: obtain a waveform of a current frame Ti, and update the waveform of the current frame Tᵢ to the second storage unit. The processing unit is further configured to perform integer modified discrete cosine transform INTMDCT on the waveform in the storage unit on the lossless encoder to obtain a second transform result.

In an embodiment, the processing unit is further configured to initialize the first storage unit before performing integer window time domain aliasing cancellation INT winTDAC on the waveform in the storage unit on the lossless encoder.

In an embodiment, both the waveform of the previous frame Tᵢ₋₁ and the waveform of the current frame Tᵢ include N non-aliased data points in time domain, and Nis a positive integer; the first transform result includes N/2 aliased data points in time domain; and the second transform result includes N/2 aliased data points in time domain and N data points in frequency domain.

In an embodiment, the processing unit is further configured to update the N/2 aliased data points in time domain in the second transform result to the first storage unit.

In an embodiment, the apparatus further includes: an encoding unit, configured to quantize and encode the N data points in frequency domain in the second transform result to obtain an encoded bitstream corresponding to the current frame Tᵢ.

According to a sixth aspect, this application provides an encoding apparatus, the encoding apparatus includes a lossy encoder. Storage units on the lossy encoder include a third storage unit and a fourth storage unit. The third storage unit is configured to store a waveform of a previous frame Tᵢ₋₁, and the fourth storage unit is configured to store a waveform of a current frame Tᵢ. The encoding apparatus further includes: an obtaining unit, configured to: obtain the waveform of the previous frame Tᵢ₋₁, and update the waveform of the previous frame Tᵢ₋₁ to the third storage unit, where the waveform of the previous frame Tᵢ₋₁ is encoded by a lossless encoder in the encoding apparatus, and the obtaining unit is further configured to: obtain the waveform of the current frame Tᵢ, and update the waveform of the current frame Tᵢ to the fourth storage unit; and a processing unit, configured to perform modified discrete cosine transform MDCT on the waveform in the storage unit on the lossy encoder to obtain a third transform result.

In an embodiment, both the waveform of the previous frame Tᵢ₋₁ and the waveform of the current frame Tᵢ include N non-aliased data points in time domain, and N is a positive integer; and the third transform result includes N data points in frequency domain.

In an embodiment, the encoding apparatus further includes: an encoding unit, configured to quantize and encode the third transform result to obtain an encoded bitstream corresponding to the current frame Tᵢ.

According to a seventh aspect, this application provides a decoding apparatus. The decoding apparatus includes a lossless decoder. Storage units on the lossless decoder include a fifth storage unit and a sixth storage unit. The fifth storage unit is configured to store waveform data, and the sixth storage unit is configured to store spectral data. The decoding apparatus further includes: an obtaining unit, configured to: obtain a spectrum of a current frame Tᵢ, and update the spectrum of the current frame Tᵢ to the sixth storage unit; and a processing unit, configured to perform integer inverse modified discrete cosine transform INTIMDCT on a spectrum in the storage unit on the lossless decoder to obtain a fourth transform result. The obtaining unit is further configured to obtain an overlapped frame of a previous frame Tᵢ₋₁. The processing unit is further configured to perform overlap-add OLA on the overlapped frame of the previous frame Tᵢ₋₁ and a non-aliased waveform in the fourth transform result to obtain a waveform of the current frame Ti, where the spectrum of the previous frame Tᵢ₋₁ is decoded by a lossy decoder in the decoding apparatus.

In an embodiment, the processing unit is further configured to initialize the fifth storage unit before performing integer inverse modified discrete cosine transform INTIMDCT on the spectrum in the storage unit on the lossless decoder.

In an embodiment, the spectrum of the current frame Tᵢ includes N data points in frequency domain, and N is a positive integer; and the non-aliased waveform in the fourth transform result includes N non-aliased data points in time domain.

In an embodiment, the fourth transform result further includes N/2 aliased data points in time domain, and the processing unit is further configured to update the N/2 aliased data points in time domain to the fifth storage unit.

In an embodiment, the decoding apparatus further includes: a decoding unit, configured to perform decoding and dequantization processing on a received encoded bitstream, where the spectrum of the current frame Ti is obtained from a processing result.

According to an eighth aspect, this application provides a decoding apparatus. The decoding apparatus includes a lossy decoder and a lossless decoder. Storage units on the lossy decoder include a seventh storage unit. The seventh storage unit is configured to store spectral data. The decoding apparatus further includes: an obtaining unit, configured to: obtain a spectrum of a current frame Tᵢ, and update the spectrum of the current frame Tᵢ to the seventh storage unit; and a processing unit, configured to perform inverse modified discrete cosine transform IMDCT on the data in the storage unit on the lossy decoder to obtain a fifth transform result. The processing unit is further configured to perform inverse integer window time domain aliasing cancellation Inverse INT winTDAC on an overlapped frame of a previous frame Tᵢ₋₁ in a storage unit on the lossless decoder to obtain a sixth transform result, where a spectrum of the previous frame Tᵢ₋₁ is decoded by the lossless decoder. The processing unit is further configured to perform overlap-add OLA on a non-aliased waveform in the sixth transform result and a corresponding waveform in the fifth transform result to obtain a waveform of the current frame Tᵢ.

In an embodiment, the storage units on the lossy decoder further include an eighth storage unit. The eighth storage unit is configured to store waveform data. The processing unit is further configured to update an overlapped frame of the current frame Tᵢ in the fifth transform result to the eighth storage unit.

In an embodiment, the fifth transform result includes the overlapped frame of the current frame Tᵢ and a time domain non-aliased waveform corresponding to the current frame Tᵢ; and the time domain non-aliased waveform corresponding to the current frame Tᵢ corresponds to the non-aliased waveform in the sixth transform result.

In an embodiment, the processing unit is further configured to initialize the eighth storage unit before performing inverse modified discrete cosine transform IMDCT on the data in the storage unit on the lossy decoder.

In an embodiment, the processing unit is further configured to initialize a ninth storage unit in the storage unit on the lossless decoder before performing inverse integer window time domain aliasing cancellation Inverse INT winTDAC on the overlapped frame of the previous frame Tᵢ₋₁ in the storage unit on the lossless decoder, where the ninth storage unit is configured to store spectral data.

In an embodiment, the decoding apparatus further includes: a decoding unit, configured to perform decoding and dequantization processing on a received encoded bitstream, where the spectrum of the current frame Tᵢ is obtained from a processing result.

According to a ninth aspect, this application provides an encoder, including a processing circuit configured to perform the method according to any one of the first aspect and the second aspect.

According to a tenth aspect, this application provides a decoder, including a processing circuit configured to perform the method according to any one of the third aspect and the fourth aspect.

According to an eleventh aspect, this application provides an encoder, including: one or more processors; and a non-transitory computer-readable storage medium coupled to the processor and storing a program executed by the processor. When the program is executed by the processor, the encoder is enabled to perform the method according to any one of the first aspect and the second aspect.

According to a twelfth aspect, this application provides a decoder, including: one or more processors; and a non-transitory computer-readable storage medium coupled to the processor and storing a program executed by the processor. When the program is executed by the processor, the decoder is enabled to perform the method according to any one of the third aspect and the fourth aspect.

According to a thirteenth aspect, an embodiment of this application provides a computer program product, including program code. When the program code is executed on a computer or a processor, the program code is configured to perform the method according to any one of the first aspect to the fourth aspect.

According to a fourteenth aspect, an embodiment of this application provides a non-transitory computer-readable storage medium, including program code. When the program code is executed by a computer device, the program code is configured to perform the method according to any one of the first aspect to the fourth aspect.

### BRIEF DESCRIPTION OF DRAWINGS

The following describes accompanying drawings used in embodiments of this application.

FIG. 1 is a diagram of a system architecture according to an embodiment of this application;

FIG. 2 is a schematic flowchart of an encoding and decoding process according to an embodiment of this application;

FIG. 3(a) and FIG. 3(b) are diagrams of data change processes in a lossy codec buffer according to an embodiment of this application;

FIG. 4(a) and FIG. 4(b) are diagrams of data change processes in a lossless codec buffer according to an embodiment of this application;

FIG. 5 is a flowchart of a method for switching from a lossy encoder to a lossless encoder according to an embodiment of this application;

FIG. 6 is a diagram of a data change process in a lossless encoder buffer according to an embodiment of this application;

FIG. 7 is a flowchart of a method for switching from a lossless encoder to a lossy encoder according to an embodiment of this application;

FIG. 8 is a diagram of a data change process in a lossy encoder buffer according to an embodiment of this application;

FIG. 9 is a flowchart of a method for switching from a lossy decoder to a lossless decoder according to an embodiment of this application;

FIG. 10 is a diagram of a data change process in a lossless decoder buffer according to an embodiment of this application;

FIG. 11 is a flowchart of a method for switching from a lossless decoder to a lossy decoder according to an embodiment of this application;

FIG. 12 is a diagram of a data change process in a lossy decoder buffer according to an embodiment of this application;

FIG. 13 is a diagram of a structure of an encoding apparatus according to an embodiment of this application;

FIG. 14 is a diagram of a structure of an encoding apparatus according to an embodiment of this application;

FIG. 15 is a diagram of a structure of a decoding apparatus according to an embodiment of this application; and

FIG. 16 is a diagram of a structure of a decoding apparatus according to an embodiment of this application.

### DESCRIPTION OF EMBODIMENTS

The following describes embodiments of this application with reference to the accompanying drawings in embodiments of this application. In the descriptions of embodiments of this application, unless otherwise stated, “/” represents “or”. For example, A/B may represent A or B. In this specification, “and/or” merely describes an association relationship between associated objects and represents that three relationships may exist. For example, A and/or B may represent the following three cases: Only A exists, both A and B exist, and only B exists. In addition, in the descriptions of embodiments of this application, “a plurality of” means two or more than two.

In the specification, claims, and accompanying drawings of this application, the terms “first”, “second”, “third”, “fourth” and so on are intended to distinguish between different objects but do not indicate a particular order. In addition, the terms “including” and “having” and any other variants thereof are intended to cover a non-exclusive inclusion. For example, a process, a method, a system, a product, or a device that includes a series of operations or units is not limited to the listed operations or units, but optionally further includes an unlisted operation or unit, or optionally further includes another inherent operation or unit of the process, the method, the product, or the device. “Embodiments” mentioned herein mean that specific features, structures, or characteristics described in combination with embodiments may be included in at least one embodiment of this application. The phrase shown in various locations in the specification may not necessarily refer to a same embodiment, and is not an independent or optional embodiment exclusive from another embodiment. It is explicitly and implicitly understood by a person skilled in the art that embodiments described in the specification may be combined with another embodiment.

The following describes technical terms in this application.

(1) Modified discrete cosine transform (MDCT): a method for converting a time domain signal into a frequency domain signal. Inverse modified discrete cosine transform (IMDCT) is an inverse transform of MDCT, that is, a method for converting a frequency domain signal into a time domain signal. An MDCT/IMDCT transform pair is a lossy data compression means most widely used in the audio compression field, is transform derived from Fourier transform, and is characterized by eliminating time domain aliasing. In this application, a lossy codec implements conversion between time domain and frequency domain based on the MDCT/IMDCT transform pair.

(2) Integer modified discrete cosine transform (INTMDCT): Similar to MDCT, integer modified discrete cosine transform is also a method for converting a time domain signal into a frequency domain signal. However, in an INTMDCT process, an input waveform and an output spectrum are integers. An inverse transform process of INTMDCT is integer inverse modified discrete cosine transform (INTIMDCT). In this process, an integer spectrum may be restored to an integer waveform. An INTMDCT/INTIMDCT transform pair and a completely reversible quantization encoding/dequantization encoding module may form a digitally lossless audio codec. A lossless codec in this application implements transform between time domain and frequency domain based on the INTMDCT/INTIMDCT transform pair.

(3) Pulse-code modulation (PCM): a method for digitizing an analog signal, including three processes: sampling, quantization, and encoding. PCM audio data in this application is time domain data obtained after PCM processing is performed on an analog audio signal.

(4) Lossy encoder buffer: a buffer (buffer) in a lossy encoder, including two parts. In this application, the two parts are named a previous frame buffer and a current frame buffer. After a lossy encoding process of a current frame ends (excluding a switching process between lossless encoding and lossy encoding), the current frame buffer is configured to store a waveform of the current frame Tᵢ, and the previous frame buffer is configured to store an overlapped frame of the current frame.

(5) Lossless encoder buffer: a buffer (buffer) in a lossless encoder, including two parts. In this application, the two parts are named an overlapped buffer and an input frame buffer. After a lossless encoding process of a current frame ends (excluding a switching process between lossless encoding and lossy encoding), the input frame buffer is configured to store a waveform of the current frame Tᵢ, and the overlapped buffer is configured to store an overlapped frame of the current frame.

(6) Lossy decoder buffer: a buffer (buffer) in a lossy decoder, including two parts. In this application, the two parts are named a next frame buffer and a current frame buffer. After a lossy decoding process of a current frame ends (excluding a switching process between lossless decoding and lossy decoding), the current frame buffer is configured to store a spectrum of the current frame Tᵢ, and the next frame buffer is configured to store an overlapped frame of the current frame.

(7) Lossless decoder buffer: a buffer (buffer) in a lossless decoder, including two parts. In this application, the two parts are named an overlapped buffer and an input frame buffer. After a lossless decoding process of a current frame ends (excluding a switching process between lossless decoding and lossy decoding), the input frame buffer is configured to store a spectrum of the current frame Tᵢ, and the overlapped buffer is configured to store an overlapped frame of the current frame.

(8) Overlapped frame: When coding is performed on a current frame Tᵢ, buffer data generated by the current frame Tᵢ is used to perform overlap-add with a next frame during coding of the next frame, to obtain a correct waveform or spectrum of the next frame.

(9) Switching frame: In this application, the switching frame is a frame of audio data coded by a lossless codec when a lossy codec is switched to the lossless codec, or a frame of audio data that is coded by a lossy codec when a lossless codec is switched to the lossy codec. After coding of the switching frame is completed, switching between the lossy codec and the lossless codec is completed.

(10) Frequency domain codec: A data type processed by an encoder in a process of performing quantization and encoding to obtain an encoded bitstream (bitstream) is frequency domain data, and a data type obtained by a decoder by performing decoding and dequantization on a received encoded bitstream is frequency domain data. Similarly, in a time domain codec, the data types corresponding to the foregoing processes are time domain data.

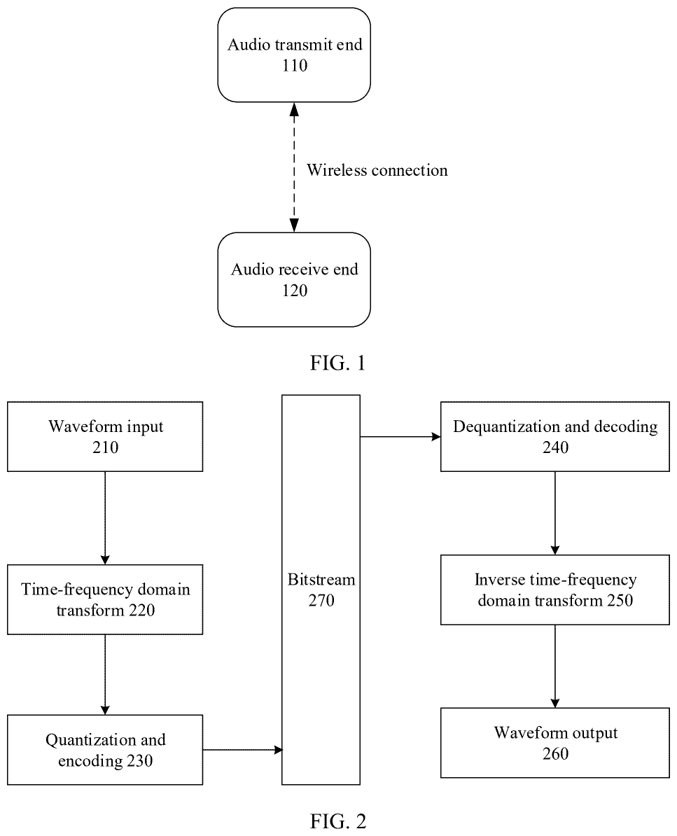

FIG. 1 is a diagram of a system architecture according to an embodiment of this application, and is used to describe an application scenario to which a method for switching from a lossy codec to lossless codec in this application is applicable.

As shown in FIG. 1, the system architecture includes an audio transmit end 110 and an audio receive end 120, and the audio transmit end 110 and the audio receive end 120 are wirelessly connected.

In an embodiment, a manner of wireless connection between the audio transmit end 110 and the audio receive end 120 may be a Bluetooth connection, a Wi-Fi connection, or the like. This is not limited in this application.

In an embodiment, the audio transmit end 110 is a device capable of performing lossy audio coding and lossless audio coding and having a capability of sending an audio data stream. For example, the audio transmit end may be a device such as a mobile phone, a computer, a tablet, or in-vehicle infotainment, which are not listed one by one in this application.

In an embodiment, the audio receive end 120 is a device capable of performing lossy audio coding and lossless audio coding on a received audio data stream and playing the audio data stream. For example, the audio receive end may be a true wireless stereo (True Wireless Stereo, TWS) headset, a common wireless headset, a stereo, a smartwatch, smart glasses, or the like, which are not listed one by one in this application.

Both the lossy codec and the lossless codec described in this application are audio codecs, and a waveform of each frame or a spectrum of each frame is audio data.

FIG. 2 is a schematic flowchart of an encoding and decoding process according to an embodiment of this application.

As shown in FIG. 2, operation 210 to operation 230 are a process in an encoder, and may be a process in an encoder at the audio transmit end 110 in FIG. 1.

In an audio encoding process, operation 210: waveform input, is performed first. Specifically, a waveform of a current frame Tᵢ is obtained from PCM audio data. Then, time-frequency domain transform 220 is performed to convert the waveform of the current frame Tᵢ into a spectrum of the current frame Tᵢ. Finally, quantization and encoding 230 are performed to obtain an encoded bitstream of the current frame, that is, a bitstream 270 in FIG. 2.

Operation 210 to operation 230 may be an encoding process in a lossy encoder, an encoding process in a lossless encoder, or an encoding process during switching between a lossy encoder and a lossless encoder. When operation 210 to operation 230 indicate the encoding process during switching between the lossy encoder and the lossless encoder, corresponding pre-processing is required before time-frequency domain transform 220 is performed. A specific pre-processing process is described in the following method embodiment for switching from the lossy encoder to the lossless encoder and the following method embodiment for switching from the lossless encoder to the lossy encoder.

A transform method used in time-frequency domain transform 220 is MDCT or INTMDCT.

Operation 240 to operation 260 are a process in a decoder, and may be a process in a decoder at the audio receive end 120 in FIG. 1.

In an audio decoding process, the decoder performs dequantization and decoding 240 on a received bitstream 270, to obtain corresponding spectral data. Then, the spectrum of the current frame Tᵢ is obtained, and inverse time-frequency domain transform 250 is performed on the spectrum of the current frame Tᵢ to obtain waveform output 260 of the current frame Tᵢ.

Operation 240 to operation 260 may be a decoding process in a lossy decoder, a decoding process in a lossless decoder, or a decoding process during switching between a lossy decoder and a lossless decoder. When operation 240 to operation 260 indicate the decoding process of switching between the lossy decoder and the lossless decoder, corresponding pre-processing is required before inverse time-frequency domain transform 250 is performed, and corresponding post-processing is required after inverse time-frequency domain transform 250 is performed. Specific pre-processing and post-processing processes are described in the following method embodiment for switching from the lossy decoder to the lossless decoder and the following method embodiment for switching from the lossless decoder to the lossy decoder.

A transform method used in inverse time-frequency domain transform 250 is IMDCT or INTIMDCT.

The following describes principles and corresponding execution processes of an MDCT/IMDCT transform pair and an INTMDCT/INTIMDCT transform pair used in this application.

A mathematical principle of MDCT transform is shown in Formula (1):

$$X ( k ) = {\sum }_{i = 0}^{2 N - 1} w ( i ) {x}_{i} cos [ \frac{π}{N} ( i + \frac{1}{2} + \frac{N}{2} ) ( k + \frac{1}{2} ) ] , k = 0 , … N - 1 \qquad ( 1 )$$

xᵢ and X(k) respectively indicate original time domain data and changed frequency data obtained through MDCT, and N indicates a frame length. i and k respectively indicate a data point in time domain before transform and a data point in frequency domain after transform. w(i) indicates a window function.

Formula (1) indicates that time domain data whose length is 2N is changed to frequency domain data whose length is N.

MDCT may be divided into two processes: window time domain aliasing cancellation (Window Time Domain Aliasing Cancellation, winTDAC) and discrete cosine transform DCT4 (Discrete Cosine Transform-4, DCT4). If a 2N-point PCM input waveform and a corresponding window are evenly divided into four consecutive parts, MDCT may be expressed as Formula (2):

$$MDCT ( {w}_{1} a , {w}_{2} b , {w}_{3} c , {w}_{4} d ) = DCT 4 ( - {( {w}_{3} c )}_{R} - ( {w}_{4} d ) , ( {w}_{1} a ) - {( {w}_{2} b )}_{R} ) \qquad ( 2 )$$

a, b, c, and d each indicate an N/2-point PCM input waveform obtained through even division. w₁, w₂, w₃, and w₄ each indicate an N/2-point window obtained through even division. R indicates that a corresponding sequence is reversed.

It can be seen that a winTDAC process is to multiply the 2N-point PCM input waveform by the corresponding window, and then fold the 2N-point PCM input waveform into N points according to the formula, to facilitate subsequent DCT4 processing. A main purpose of windowing is to prevent spectrum leakage, and a main purpose of aliasing is to fold a sequence into a form processable by DCT4.

INTMDCT is similar to MDCT. An INTMDCT process also includes two main processes: a window time domain aliasing cancellation process and a DCT4 transform process. However, with the help of Givens rotation and Lifting transform, forward transform and inverse transform of INTMDCT are completely reversible, but the MDCT/IMDCT transform pair has a floating point number calculation error.

The window time domain aliasing cancellation process of INTMDCT is different from that of MDCT, and is integer window time domain aliasing cancellation (Integer Window Time Domain Aliasing Cancellation, INT winTDAC). DCT4 transform in INTMDCT is INTDCT4 transform based on Givens rotation and Lifting transform, which is also different from that in MDCT.

Both a PCM input waveform and an output spectrum of INTMDCT are integers. Through the inverse transform of INTMDCT, namely, INTIMDCT, an integer spectrum may be restored to integer PCM, which is completely bit-consistent with the input PCM. An only difference lies in that there is a sequence latency of several points. Therefore, the INTMDCT/INTIMDCT transform pair and a completely reversible quantization encoding/dequantization encoding module may form a digitally lossless audio codec.

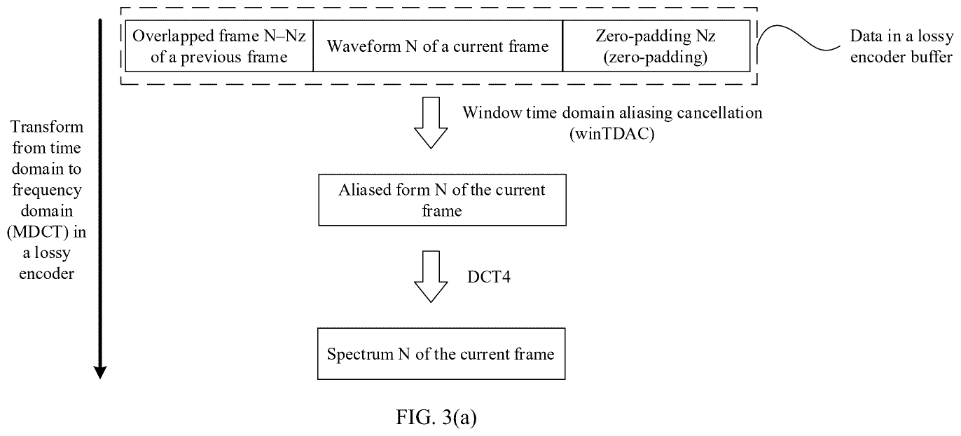

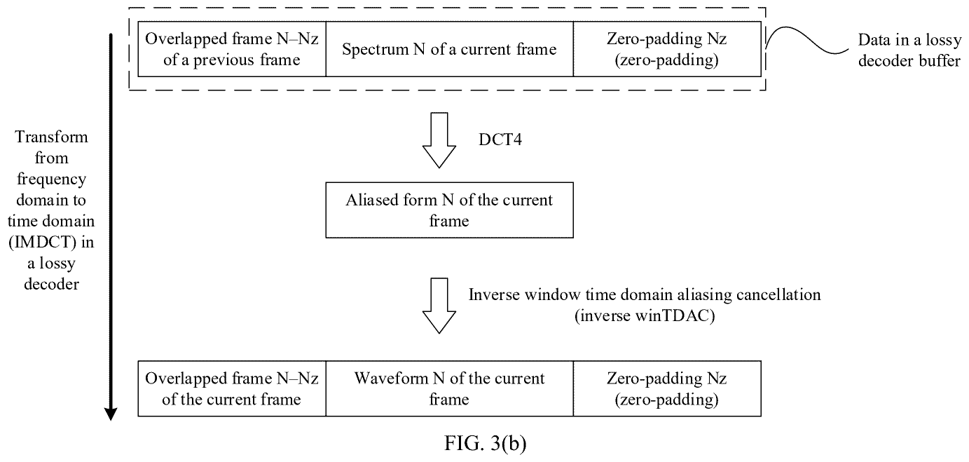

With reference to FIG. 3(a) and FIG. 3(b), the following describes data changes in a lossy codec buffer in an MDCT process and an IMDCT process in a lossy codec.

FIG. 3(a) shows transform from time domain to frequency domain (namely, MDCT) in lossy encoding. FIG. 3(a) shows a process of performing MDCT on a waveform of a current frame Tᵢ in a lossy encoder to obtain a spectrum of the current frame Tᵢ.

A lossy encoder buffer includes a current frame buffer and a previous frame buffer.

As shown in FIG. 3(a), before MDCT is performed on the waveform of the current frame Tᵢ, the current frame buffer stores a waveform N of the current frame Tᵢ, and the previous frame buffer stores an overlapped frame N−Nz of a previous frame. Zero-padding (Zero-padding) indicates that values of Nz data points thereon are zero.

N, N−Nz, and Nz in FIG. 3(a) indicate quantities of included data points.

When MDCT starts to be performed, window time domain aliasing cancellation (namely, winTDAC) is first performed on 2N data points in the lossy encoder buffer, to obtain an aliased form N of the current frame. Then, a DCT4 process is performed on the aliased form N of the current frame, to obtain a spectrum N of the current frame Tᵢ.

FIG. 3(b) shows transform from frequency domain to time domain (namely, IMDCT) in lossy decoding. FIG. 3(b) shows a process of performing IMDCT on a spectrum of a current frame Tᵢ in a lossy decoder to obtain a waveform of the current frame Tᵢ.

A lossy decoder buffer includes a current frame buffer and a next frame buffer.

As shown in FIG. 3(b), before IMDCT is performed on the spectrum of the current frame Tᵢ, the current frame buffer stores a spectrum N of the current frame Tᵢ, and the next frame buffer stores an overlapped frame N−Nz of a previous frame. Zero-padding indicates that values of Nz data points thereon are zero.

N, N−Nz, and Nz in FIG. 3(b) indicate quantities of included data points.

When IMDCT starts to be performed, a DCT4 process is first performed on 2N data points in the lossy decoder buffer, to obtain an aliased form N of the current frame. Then, inverse window time domain aliasing cancellation (Inverse winTDAC) is performed on the aliased form N of the current frame, to obtain a waveform N of the current frame Tᵢ, an overlapped frame N−Nz of the current frame, and Nz zero-padding data points.

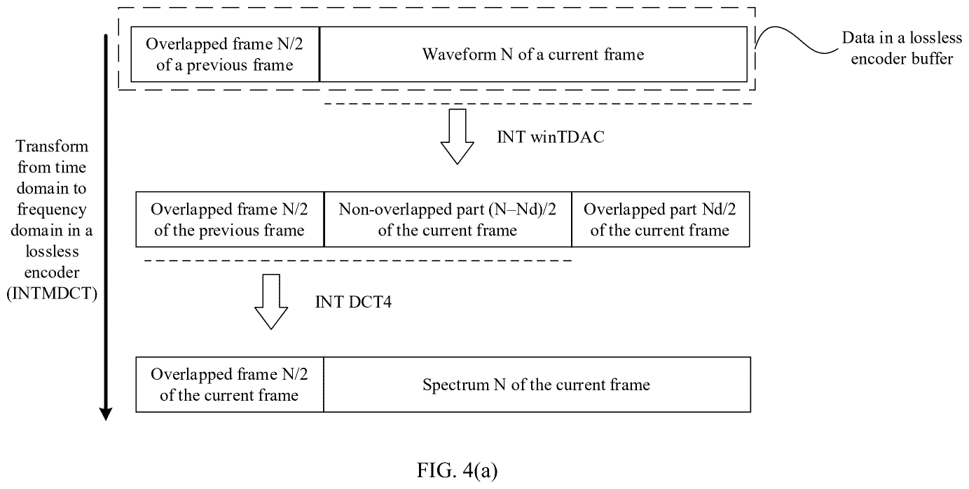

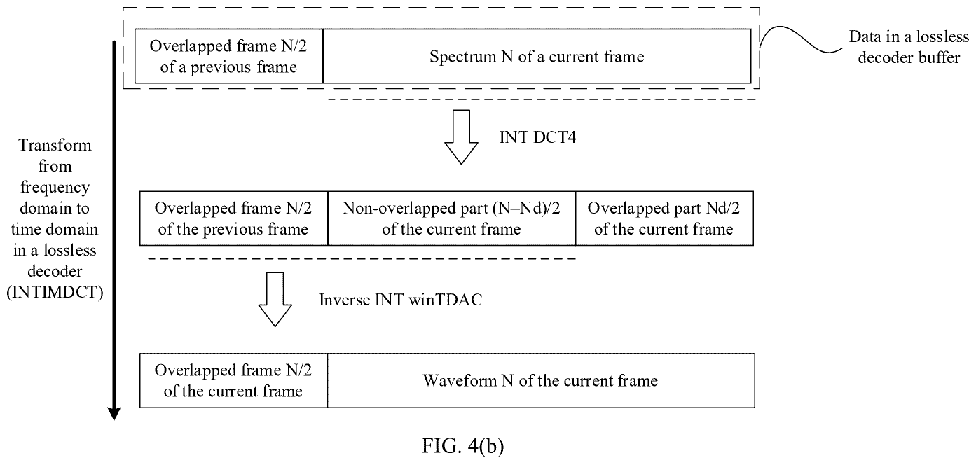

With reference to FIG. 4(a) and FIG. 4(b), the following describes data changes in a lossless codec buffer in an INTMDCT process and an INTIMDCT process in a lossless codec.

FIG. 4(a) shows transform from time domain to frequency domain (INTMDCT) in lossless encoding. FIG. 4(a) shows a process of performing INTMDCT on a waveform of a current frame Tᵢ in a lossless encoder to obtain a spectrum of the current frame Tᵢ.

A lossless encoder buffer includes an input frame buffer and an overlapped buffer.

As shown in FIG. 4(a), before INTMDCT is performed on a waveform N of the current frame Tᵢ, the input frame buffer stores the waveform N of the current frame Tᵢ, and the overlapped buffer stores an overlapped frame N/2 of a previous frame.

N, N/2, (N−Nd)/2, and Nd/2 in FIG. 4(a) indicate quantities of included data points.

When INTMDCT starts to be performed, integer window time domain aliasing cancellation (INT winTDAC) is first performed on the waveform N of the current frame Tᵢ in the lossless encoder buffer, to obtain a non-overlapped part (N−Nd)/2 of the current frame and an overlapped part Nd/2 of the current frame. Then, an INT DCT4 process is performed on the overlapped frame N/2 of the previous frame and the non-overlapped part (N−Nd)/2 of the current frame, to obtain a spectrum N of the current frame Tᵢ and an overlapped frame N/2 of the current frame.

FIG. 4(b) shows transform from frequency domain to time domain (INTIMDCT) in lossless decoding. FIG. 4(b) shows a process of performing INTIMDCT on a spectrum of a current frame Tᵢ in a lossless decoder to obtain a waveform of the current frame Tᵢ.

A lossless decoder buffer includes an input frame buffer and an overlapped buffer.

As shown in FIG. 4(b), before INTIMDCT is performed on a spectrum N of the current frame Tᵢ, the input frame buffer stores the spectrum N of the current frame Tᵢ, and the overlapped buffer stores an overlapped frame N/2 of a previous frame.

N, N/2, (N−Nd)/2, and Nd/2 in FIG. 4 (b) indicate quantities of included data points.

When INTIMDCT starts to be performed, an INT DCT4 process is first performed on the spectrum N of the current frame Tᵢ in the lossless decoder buffer, to obtain a non-overlapped part (N−Nd)/2 of the current frame and an overlapped part Nd/2 of the current frame. Then, inverse integer window time domain aliasing cancellation (Inverse INT winTDAC) is performed on the overlapped frame N/2 of the previous frame and the non-overlapped part (N−Nd)/2 of the current frame, to obtain a waveform N of the current frame Tᵢ and an overlapped frame N/2 of the current frame.

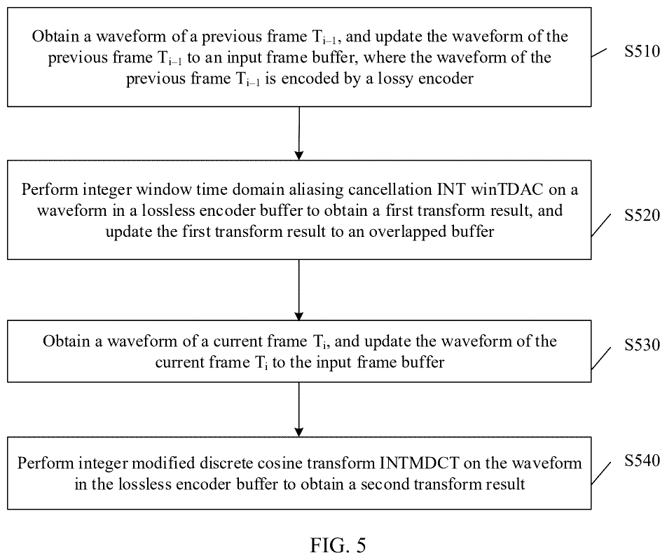

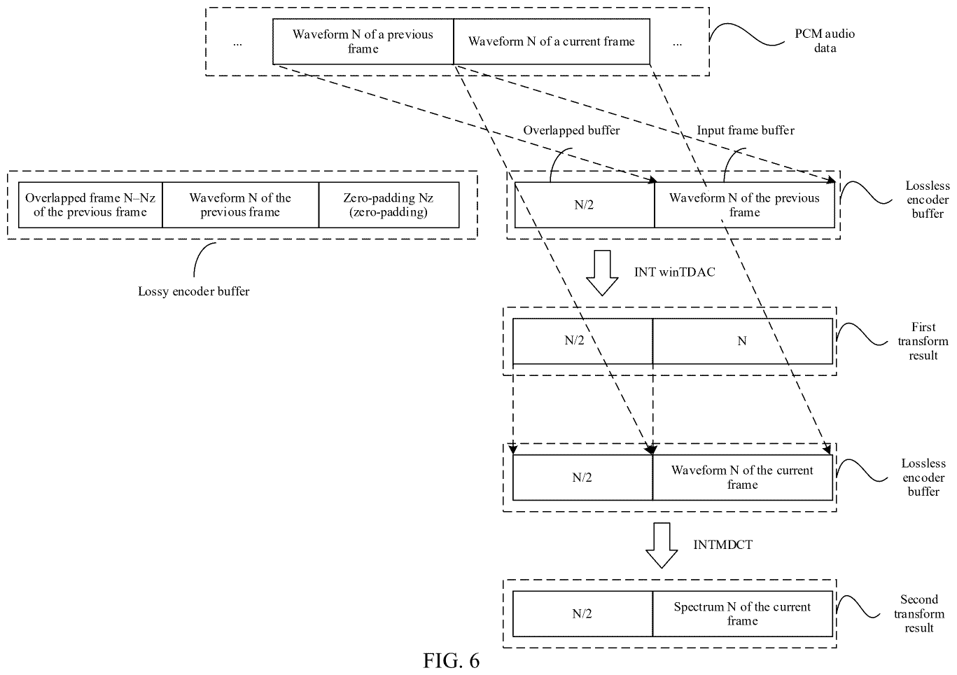

FIG. 5 is a flowchart of a method for switching from a lossy encoder to a lossless encoder according to an embodiment of this application. As shown in FIG. 5, the method includes operation S510, operation S520, operation S530, and operation S540. The following describes a data change process in a lossless encoder buffer in the method in FIG. 5 with reference to FIG. 6.

As shown in FIG. 6, the lossless encoder buffer includes an overlapped buffer and an input frame buffer. The overlapped buffer is configured to store an aliased waveform, and the input frame buffer is configured to store a non-aliased waveform.

Operation S510: Obtain a waveform of a previous frame Tᵢ₋₁, and update the waveform of the previous frame Tᵢ₋₁ to the input frame buffer, where the waveform of the previous frame Tᵢ₋₁ is encoded by the lossy encoder.

Specifically, the waveform of the previous frame Tᵢ₋₁ may be obtained from a lossy encoder buffer. The waveform of the previous frame Tᵢ₋₁ in the lossy encoder buffer is the same as a waveform of the previous frame Tᵢ₋₁ in PCM audio data.

Encoding of the waveform of the previous frame Tᵢ₋₁ has been completed by the lossy encoder, and the current frame Tᵢ is a frame encoded by the lossless encoder in a process of switching from the lossy encoder to the lossless encoder, that is, a switching frame.

In this case, data in the lossy encoder buffer is data obtained through update after the waveform of the previous frame Tᵢ₋₁ is encoded. The lossy encoder buffer includes a current frame buffer and a previous frame buffer. In this case, the current frame buffer stores the waveform of the previous frame Tᵢ₋₁, that is, a waveform of a last frame encoded by the lossy encoder before switching from the lossy encoder to the lossless encoder. The previous frame buffer stores an overlapped frame N−Nz of the previous frame. The overlapped frame N−Nz is a time domain non-aliased waveform obtained in a process of performing lossy encoding on the waveform of the previous frame Tᵢ₋₁.

That is, as shown in FIG. 6, after the waveform of the previous frame Tᵢ₋₁ is updated to the input frame buffer of the lossless encoder, both the input frame buffer in the lossless decoder buffer and the current frame buffer of the lossy encoder store the waveform of the previous frame Tᵢ₋₁ in the PCM audio data.

A waveform of each frame in the PCM audio data includes N non-aliased data points in time domain. Characters N, N−Nz, Nz, and N/2 in FIG. 6 indicate quantities of included data points.

The PCM audio data is time domain data obtained after PCM processing is performed on audio data represented by an analog signal.

A one-way arrow shown by a dashed line in FIG. 6 represents an update or replication process of corresponding data.

Operation S520: Perform integer window time domain aliasing cancellation INT winTDAC on the waveform in the lossless encoder buffer to obtain a first transform result, and update the first transform result to the overlapped buffer.

The overlapped buffer of the lossless encoder is initialized before integer window time domain aliasing cancellation INT winTDAC is performed on the waveform in the lossless encoder buffer.

In an embodiment, the initialization process is setting data in the overlapped buffer to zero. This process is used to clear a historical waveform in the overlapped buffer to eliminate impact of the historical waveform in the overlapped buffer on an INT winTDAC process.

Updating the first transform result to the overlapped buffer includes: updating a time domain aliased waveform in the first transform result to the overlapped buffer.

The time domain aliased waveform in the first transform result is N/2 aliased data points in time domain. In this case, the N/2 aliased data points in time domain are first N/2 data points in the first transform result.

Operation S530: Obtain the waveform of the current frame Tᵢ, and update the waveform of the current frame Tᵢ to the input frame buffer.

Specifically, after the first transform result is obtained, the waveform of the current frame Tᵢ is obtained from the PCM audio data, and the waveform of the current frame Tᵢ is updated to the input frame buffer of the lossless encoder.

The current frame is a frame of audio data encoded in the process of switching from the lossy encoder to the lossless encoder, that is, a switching frame.

Current frames described in four switching method embodiments of this application are all switching frames.

After update of the lossless encoder buffer is completed, the lossless encoder buffer stores data required for performing an INTMDCT process on the waveform of the current frame Tᵢ.

For details about the first transform result and data in an updated lossless encoder buffer, refer to FIG. 6.

Operation S540: Perform integer modified discrete cosine transform INTMDCT on the waveform in the lossless encoder buffer to obtain a second transform result.

Specifically, after update of the lossless encoder buffer is completed, an INTMDCT process is performed on 3N/2 data points in the lossless encoder buffer to obtain the second transform result.

The second transform result includes N/2 aliased data points in time domain and N data points in frequency domain. The N data points in frequency domain are a spectrum N of the current frame Tᵢ in the second transform result in FIG. 6. The N/2 aliased data points in time domain are an overlapped frame of the current frame, and are used to perform an INTMDCT process on a waveform of a next frame Tᵢ₊₁.

After the second transform result is obtained, the N/2 aliased data points (that is, the overlapped frame of the current frame) in time domain in the second transform result are updated to the overlapped buffer of the lossless encoder.

After the second transform result is obtained, the N data points (that is, the spectrum of the current frame Tᵢ in FIG. 6) in frequency domain in the second transform result are further quantized and encoded, to obtain an encoded bitstream corresponding to the current frame Tᵢ, that is, a bitstream sent by the audio transmit end 110 to the audio receive end 120 in FIG. 1.

In this case, data stored in the overlapped buffer and the input frame buffer in the lossless encoder buffer are the overlapped frame of the current frame and the waveform of the current frame Tᵢ respectively.

After the operations in the embodiment in FIG. 5 are performed, a lossless encoding process of the current frame (switching frame) is completed, and the process of switching from the lossy encoder to the lossless encoder is also completed. The waveform of the next frame Tᵢ₋₁ in the PCM audio data is completely encoded by the lossless encoder.

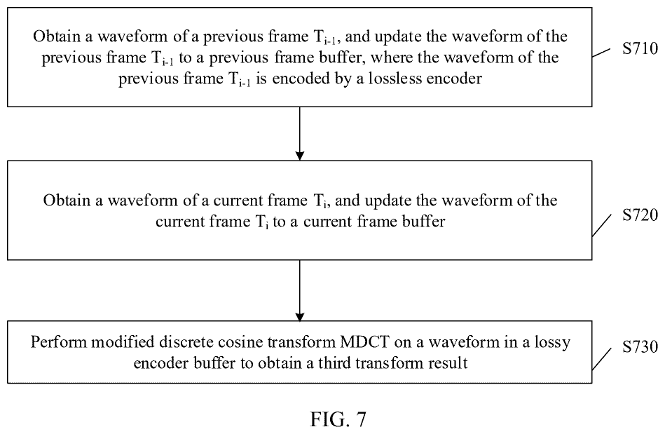

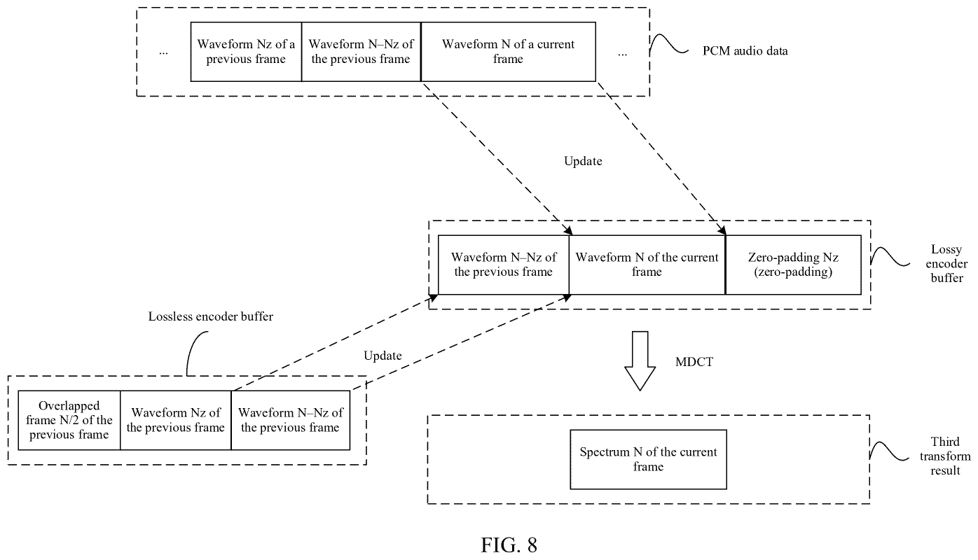

FIG. 7 is a flowchart of a method for switching from a lossless encoder to a lossy encoder according to an embodiment of this application. As shown in FIG. 7, the method includes operation S710, operation S720, and operation S730. The following describes a data change process in a lossy encoder buffer in the method in FIG. 7 with reference to FIG. 8.

The lossy encoder buffer includes two parts: a previous frame buffer and a current frame buffer. The previous frame buffer is configured to store a waveform of a previous frame Tᵢ₋₁, and the current frame buffer is configured to store a waveform of a current frame Tᵢ.

Operation S710: Obtain the waveform of the previous frame Tᵢ₋₁, and update the waveform of the previous frame Tᵢ₋₁ to the previous frame buffer, where the waveform of the previous frame Tᵢ₋₁ is encoded by the lossless encoder.

Specifically, the waveform of the previous frame Tᵢ₋₁ may be obtained from a lossless encoder buffer.

In an embodiment, as shown in FIG. 8, the obtained waveform of the previous frame Tᵢ₋₁ may include only N−Nz aliased data points in time domain in the waveform of the previous frame Tᵢ₋₁.

As shown in FIG. 8, the waveform of the previous frame Tᵢ₋₁ in the lossless encoder buffer is the same as a waveform of the previous frame Tᵢ₋₁ in PCM audio data.

Encoding of the waveform of the previous frame Tᵢ₋₁ has been completed by the lossless encoder, and the current frame Tᵢ is a frame encoded by the lossless encoder in a process of switching from the lossy encoder to the lossless encoder, that is, a switching frame.

In this case, data in the lossless encoder buffer is data obtained through update after the waveform of the previous frame Tᵢ₋₁ is encoded. The lossless encoder buffer includes an overlapped buffer and an input frame buffer. In this case, the input frame buffer stores the waveform (N−Nz and Nz data points) of the previous frame Tᵢ₋₁, and there are N data points in total. The waveform of the previous frame Tᵢ₋₁ is also a waveform of a last frame encoded by the lossless encoder before switching from the lossless encoder to the lossy encoder. The overlapped buffer stores an overlapped frame N/2 of the previous frame. The overlapped frame N/2 is a time domain aliased waveform obtained in a process of performing, by the lossless encoder, lossless encoding on the waveform of the previous frame Tᵢ₋₁.

As shown in FIG. 8, in the input frame buffer of the lossless encoder and the PCM audio data, the waveform of the previous frame Tᵢ₋₁ includes N−Nz non-aliased data points in time domain and Nz zero-padding data points, that is, a total of N data points.

Operation S720: Obtain the waveform of the current frame Tᵢ, and update the waveform of the current frame Tᵢ to the current frame buffer.

The waveform of the current frame Tᵢ is obtained from the PCM audio data.

As shown in FIG. 8, the waveform of the current frame Tᵢ includes N non-aliased data points in time domain.

The current frame is a frame of audio data encoded by the lossy encoder in the process of switching from the lossless encoder to the lossy encoder, that is, a switching frame.

After update of the lossy encoder buffer is completed, the lossy encoder buffer stores data required for performing an MDCT process on the waveform of the current frame Tᵢ. For details of data in the lossy encoder buffer, refer to the diagram in FIG. 8.

A one-way arrow shown by a dashed line in FIG. 8 represents an update or replication process of corresponding data.

Operation S730: Perform modified discrete cosine transform MDCT on the waveform in the lossy encoder buffer to obtain a third transform result.

Specifically, an MDCT process is performed on 2N data points in the lossy encoder buffer to obtain the third transform result.

As shown in FIG. 8, the third transform result includes N data points (that is, a spectrum N of the current frame Tᵢ) in frequency domain.

Further, after the third transform result is obtained, quantization and encoding are performed on the third transform result to obtain an encoded bitstream of the current frame.

After the operations in the embodiment in FIG. 7 are performed, a lossy encoding process of the current frame (switching frame) is completed, and the process of switching from the lossless encoder to the lossy encoder is also completed. A waveform of a next frame Tᵢ₊₁ in the PCM audio data is completely encoded by the lossy encoder.

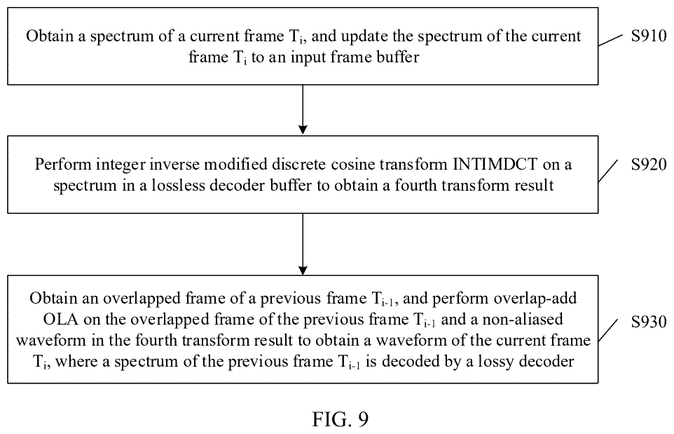

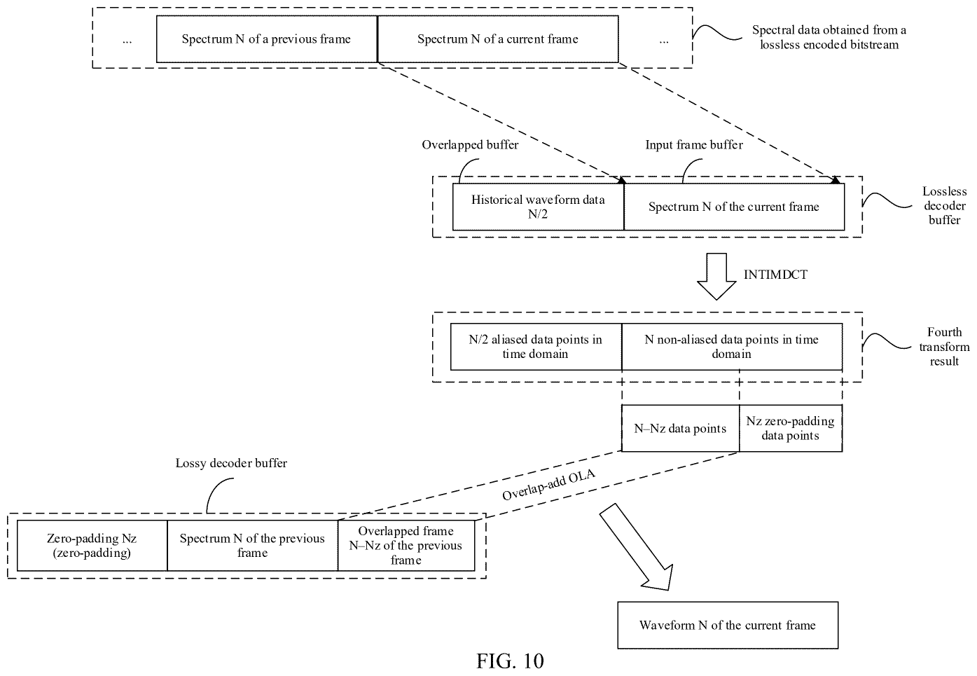

FIG. 9 is a flowchart of a method for switching from a lossy decoder to a lossless decoder according to an embodiment of this application. As shown in FIG. 9, the method includes operation S910, operation S920, and operation S930. The following describes a data change process in a lossless decoder buffer in the method in FIG. 9 with reference to FIG. 10.

The lossless decoder buffer includes two parts: an overlapped buffer and an input frame buffer. The overlapped buffer is configured to store waveform data, and the input frame buffer is configured to store spectral data.

Operation S910: Obtain a spectrum of a current frame Tᵢ, and update the spectrum of the current frame Tᵢ to the input frame buffer.

Specifically, after receiving an encoded bitstream, the lossless decoder performs decoding and dequantization on the encoded bitstream, to obtain spectral data obtained from a lossless encoded bitstream shown in FIG. 10. The spectrum of the current frame Tᵢ is obtained from the spectral data.

As shown in FIG. 10, the spectrum of the current frame Tᵢ includes N data points in frequency domain, where N is a positive integer.

As shown in FIG. 10, before INTIMDCT is performed, the overlapped buffer of the lossless decoder stores historical waveform data (N/2 data points), and the historical waveform data does not match the current frame and cannot be used to perform an INTMDCT process on the spectrum of the current frame Tᵢ.

Therefore, before INTMDCT is executed, corresponding pre-processing is required: initializing the overlapped buffer.

In an embodiment, the initialization process is setting the historical waveform data in the overlapped buffer to zero.

Operation S920: Perform integer inverse modified discrete cosine transform INTIMDCT on a spectrum in the lossless decoder buffer to obtain a fourth transform result.

After initialization of the overlapped buffer is completed, the INTIMDCT process of a spectrum N of the current frame Tᵢ starts to be performed, to obtain the fourth transform result shown in FIG. 10.

As shown in FIG. 10, the fourth transform result includes N non-aliased data points in time domain and N/2 data points aliased in time domain.

In the process of performing time-frequency domain transform (INTIMDCT) on the spectrum of the current frame Tᵢ, the overlapped buffer lacks correct waveform data. Therefore, the N non-aliased data points in time domain in the fourth transform result are not a correct waveform of the current frame Tᵢ. However, a lossy decoder buffer stores data required for performing time-frequency domain transform on the spectrum of the current frame Tᵢ. Therefore, the correct waveform of the current frame Tᵢ may be obtained by performing operation S930.

Operation S930: Obtain an overlapped frame of a previous frame Tᵢ₋₁, and perform overlap-add OLA on the overlapped frame of the previous frame Tᵢ₋₁ and a non-aliased waveform in the fourth transform result to obtain the waveform of the current frame Tᵢ, where a spectrum of the previous frame Tᵢ₋₁ is decoded by the lossy decoder.

The lossy decoder buffer includes two parts: a current frame buffer and a next frame buffer. The current frame buffer stores the spectrum of the previous frame Tᵢ₋₁, the next frame buffer stores the overlapped frame of the previous frame, and the overlapped frame of the previous frame is data required for performing time-frequency domain transform on the spectrum of the current frame Tᵢ.

As shown in FIG. 10, the N non-aliased data points in time domain in the fourth transform result include N−Nz data points and Nz zero-padding data points.

After the overlapped frame of the previous frame is obtained, overlap-add OLA is performed on the overlapped frame (including N−Nz data points) of the previous frame and the N−Nz data points in the fourth transform result, to obtain the waveform of the current frame Tᵢ.

The N/2 aliased data points in time domain in the fourth transform result are waveform data required for performing an INTIMDCT process on a spectrum of a next frame Tᵢ₊₁. Therefore, after the N/2 aliased data points in time domain in the fourth transform result are obtained, the N/2 aliased data points in time domain are updated to the overlapped buffer.

Through update of the overlapped buffer, it can be ensured that time-frequency domain transform, namely, INTIMDCT, is performed on the spectrum of the next frame Tᵢ₊₁. The overlapped buffer stores waveform data required for the time-frequency domain transform. That is, the foregoing process of updating the overlapped buffer ensures a process of switching from the lossy decoder to the lossless decoder. After a lossless decoding process of the current frame is completed, switching to the lossless decoder is completed, and a process of performing lossless decoding on the spectrum of the next frame Tᵢ₊₁ may be independently completed by the lossless decoder.

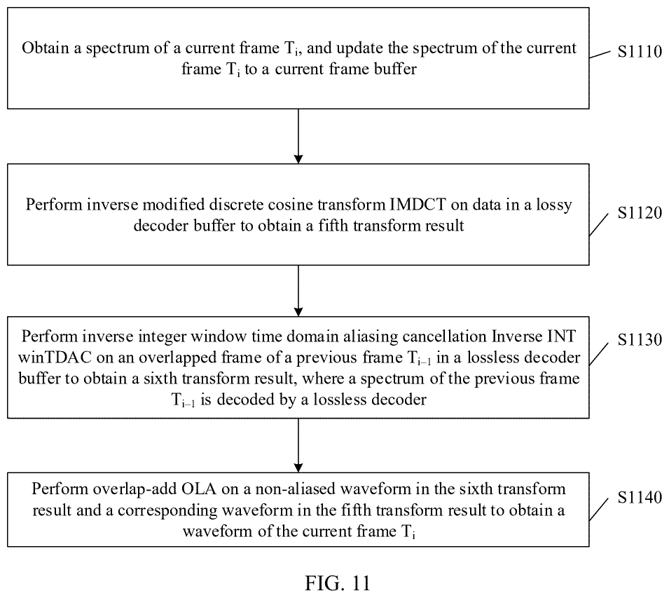

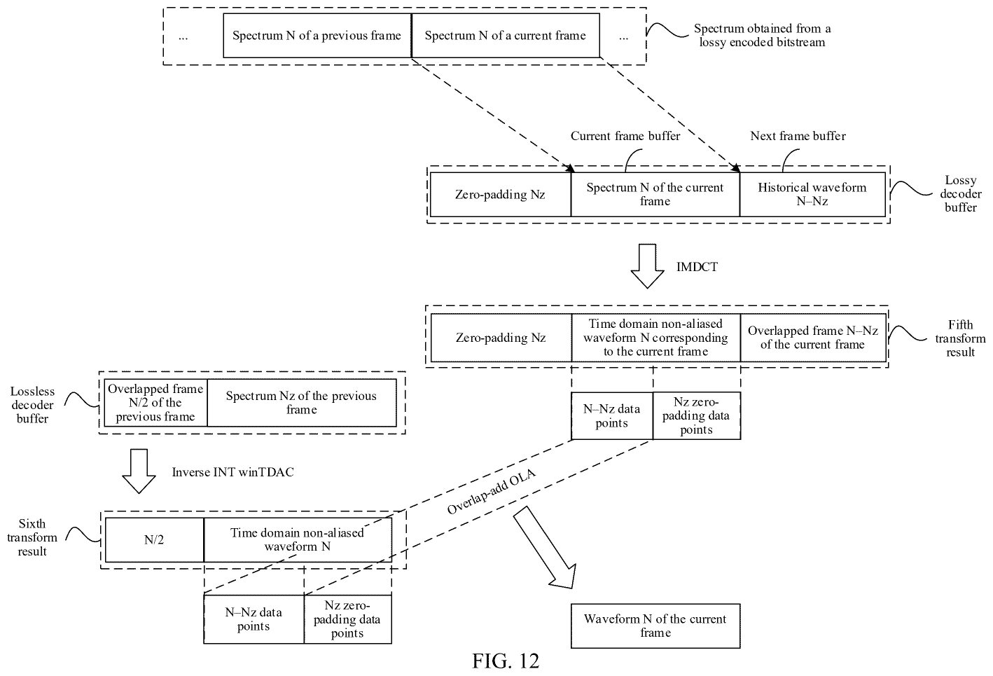

FIG. 11 is a flowchart of a method for switching from a lossless decoder to a lossy decoder according to an embodiment of this application. As shown in FIG. 11, the method includes operation S1110, operation S1120, operation S1130, and operation S1140. The following describes a data change process in a lossy decoder buffer in the method in FIG. 11 with reference to FIG. 12.

The lossy decoder buffer includes two parts: a current frame buffer and a next frame buffer. The current frame buffer is configured to store spectral data, and the next frame buffer is configured to store waveform data.

Operation S1110: Obtain a spectrum of a current frame Tᵢ, and update the spectrum of the current frame Tᵢ to the current frame buffer.

Specifically, for a process of obtaining the spectrum of the current frame Tᵢ, refer to the description corresponding to the embodiment in FIG. 9, and details are not described herein again.

Because the next frame buffer of the lossy decoder stores a historical waveform (as shown in FIG. 12, the historical waveform includes N−Nz data points), and the historical waveform does not match the current frame, the historical waveform cannot be used to perform an IMDCT process on the spectrum of the current frame Tᵢ.

To avoid interference caused by the historical waveform to the IMDCT process performed on the spectrum of the current frame Tᵢ, the next frame buffer is initialized before IMDCT is performed.

In an embodiment, the initialization process is setting the historical waveform in the next frame buffer to zero.

The foregoing initialization process may also be referred to as a pre-processing process before IMDCT is performed.

Operation S1120: Perform inverse modified discrete cosine transform IMDCT on the data in the lossy decoder buffer to obtain a fifth transform result.

After initialization of the data in the next frame buffer is completed, IMDCT is performed on the data in the lossy decoder buffer to obtain the fifth transform result.

As shown in FIG. 12, the fifth transform result includes an overlapped frame (including N−Nz data points) of the current frame Tᵢ and a time domain non-aliased waveform (including N data points) corresponding to the current frame Tᵢ.

Because the foregoing IMDCT process lacks waveform data in the next frame buffer, the time domain non-aliased waveform corresponding to the current frame Tᵢ in the fifth transform result is not a correct waveform of the current frame Tᵢ.

In this case, the correct waveform of the current frame Tᵢ may be obtained through a corresponding post-processing process (that is, operations S1130 and S1140) after IMDCT. Details are as follows:

Operation S1130: Perform inverse integer window time domain aliasing cancellation Inverse INT winTDAC on an overlapped frame of a previous frame Tᵢ₋₁ in a lossless decoder buffer to obtain a sixth transform result, where a spectrum of the previous frame Tᵢ₋₁ is decoded by the lossless decoder.

As shown in FIG. 12, the lossless decoder buffer includes two parts: an overlapped buffer and an input frame buffer. The overlapped buffer is configured to store waveform data, and the input frame buffer is configured to store spectral data. Specifically, as shown in FIG. 10, in this case, the overlapped buffer stores an overlapped frame of the previous frame, and the input frame buffer stores a spectrum of the previous frame Tᵢ₋₁.

After inverse integer window time domain aliasing cancellation Inverse INT winTDAC is performed on the overlapped frame of the previous frame, data required for performing the IMDCT process on the spectrum of the current frame Tᵢ may be obtained.

The input frame buffer in the lossless decoder buffer is initialized before Inverse INT winTDAC is performed on the overlapped frame of the previous frame Tᵢ₋₁ in the lossless decoder buffer.

In an embodiment, the foregoing process of initializing the input frame buffer in the lossless decoder is setting the data in the input frame buffer to zero.

After the foregoing initialization process is completed, an Inverse INT winTDAC process is performed on the lossless decoder buffer to obtain a sixth transform result.

As shown in FIG. 12, the sixth transform result includes a time domain non-aliased waveform (including N data points) and a time domain aliased waveform (including N/2 data points). As shown in FIG. 12, the non-aliased waveform in time domain includes two parts: N−Nz non-aliased data points and Nz zero-padding data points in time domain.

After the sixth transform result is obtained, the following operation S1140 is performed to obtain the waveform of the current frame Tᵢ. Details are as follows:

Operation S1140: Perform overlap-add OLA on the non-aliased waveform in the sixth transform result and a corresponding waveform in the fifth transform result to obtain the waveform of the current frame Tᵢ.

The time domain non-aliased waveform corresponding to the current frame Tᵢ corresponds to the non-aliased waveform in the sixth transform result.

As shown in FIG. 12, a process of overlap-add OLA in the foregoing operation S1140 is specifically: performing overlap-add OLA on N−Nz data points in the time domain non-aliased waveform corresponding to the current frame Tᵢ and the N−Nz data points in the non-aliased waveform in the sixth transform result, where an overlap-add result and the Nz zero-padding data points form a waveform N of the current frame Tᵢ.

Further, the overlapped frame of the current frame Tᵢ in the fifth transform result is updated to the next frame buffer of the lossy decoder.

The overlapped frame of the current frame Tᵢ is data that needs to be used to perform an IMDCT process on a spectrum of a next frame Tᵢ₊₁. After an update process is completed, a lossless decoding process of the spectrum of the next frame Tᵢ₊₁ may be independently completed by the lossless decoder. That is, switching from the lossless decoder to the lossy decoder is smoothly implemented.

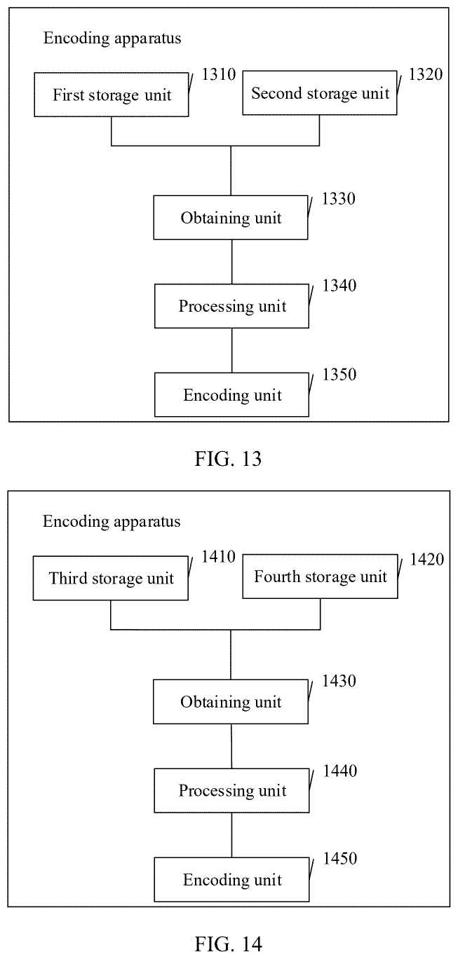

FIG. 13 is a diagram of a structure of an encoding apparatus according to an embodiment of this application. The encoding apparatus includes a first storage unit 1310, a second storage unit 1320, an obtaining unit 1330, a processing unit 1340, and an encoding unit 1350. The first storage unit 1310 is configured to store an aliased waveform, and the second storage unit 1320 is configured to store a non-aliased waveform.

The obtaining unit 1330 is configured to: obtain a waveform of a previous frame Tᵢ₋₁, and update the waveform of the previous frame Tᵢ₋₁ to the second storage unit, where the waveform of the previous frame Tᵢ₋₁ is encoded by a lossy encoder in the encoding apparatus. The processing unit 1340 is configured to: perform integer window time domain aliasing cancellation INT winTDAC on the waveform in the storage unit on the lossless encoder to obtain a first transform result, and update the first transform result to the first storage unit. The obtaining unit 1330 is further configured to: obtain a waveform of a current frame Tᵢ, and update the waveform of the current frame Tᵢ to the second storage unit. The processing unit 1340 is further configured to perform integer modified discrete cosine transform INTMDCT on the waveform in the storage unit on the lossless encoder to obtain a second transform result.

The processing unit 1340 is further configured to initialize the first storage unit before performing integer window time domain aliasing cancellation INT winTDAC on the waveform in the storage unit on the lossless encoder.

Both the waveform of the previous frame Tᵢ₋₁ and the waveform of the current frame Tᵢ include N non-aliased data points in time domain, and N is a positive integer; the first transform result includes N/2 aliased data points in time domain; and the second transform result includes N/2 aliased data points in time domain and N data points in frequency domain.

In an embodiment, the processing unit 1340 is further configured to update the N/2 aliased data points in time domain in the second transform result to the first storage unit.

The encoding unit 1350 is configured to quantize and encode the N data points in frequency domain in the second transform result to obtain an encoded bitstream corresponding to the current frame Tᵢ.

Specifically, for a specific process of each operation of the encoding apparatus in the foregoing embodiment in FIG. 13, correspondingly refer to the foregoing method embodiment for switching from the lossy encoder to the lossless encoder (that is, the embodiment in FIG. 5 and FIG. 6), and details are not described herein again.

FIG. 14 is a diagram of a structure of an encoding apparatus according to an embodiment of this application. The encoding apparatus includes a third storage unit 1410, a fourth storage unit 1420, an obtaining unit 1430, a processing unit 1440, and an encoding unit 1450. The third storage unit 1410 is configured to store a waveform of a previous frame Tᵢ₋₁, and the fourth storage unit 1420 is configured to store a waveform of a current frame Tᵢ.

The obtaining unit 1430 is configured to: obtain the waveform of the previous frame Tᵢ₋₁, and update the waveform of the previous frame Tᵢ₋₁ to the third storage unit, where the waveform of the previous frame Tᵢ₋₁ is encoded by a lossless encoder in the encoding apparatus. The obtaining unit 1430 is further configured to: obtain the waveform of the current frame Tᵢ, and update the waveform of the current frame Tᵢ to the fourth storage unit. The processing unit 1440 is configured to perform modified discrete cosine transform MDCT on the waveform in the storage unit on the lossy encoder to obtain a third transform result.

Both the waveform of the previous frame Tᵢ₋₁ and the waveform of the current frame Tᵢ include N non-aliased data points in time domain, and N is a positive integer; and the third transform result includes N data points in frequency domain.

The encoding unit 1450 is configured to quantize and encode the third transform result to obtain an encoded bitstream corresponding to the current frame Tᵢ.

Specifically, for a specific process of each operation of the encoding apparatus in the foregoing embodiment in FIG. 14, correspondingly refer to the foregoing method embodiment for switching from the lossless encoder to the lossy encoder (that is, the embodiment in FIG. 7 and FIG. 8), and details are not described herein again.

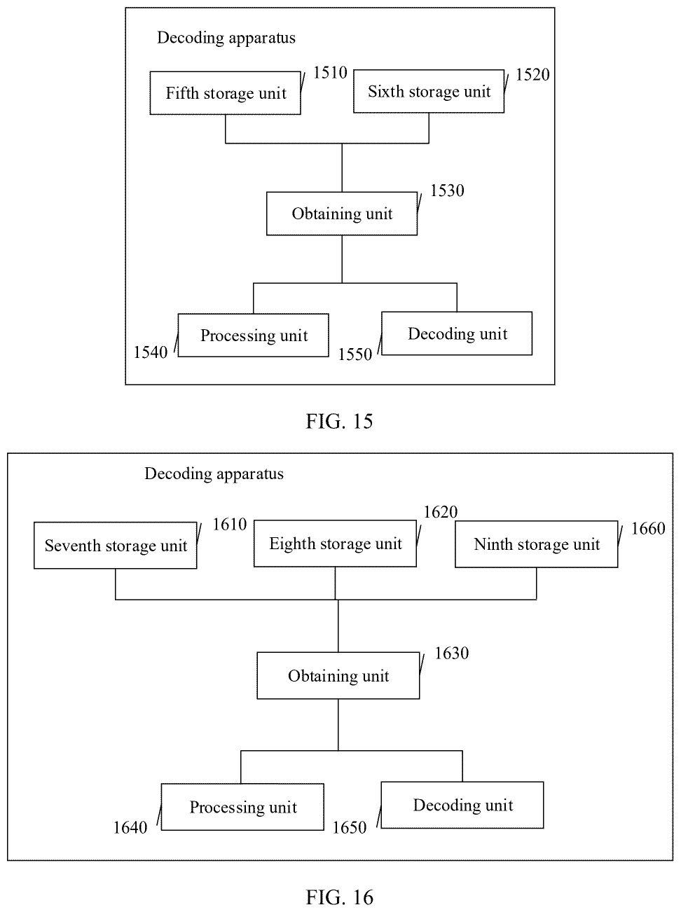

FIG. 15 is a diagram of a structure of a decoding apparatus according to an embodiment of this application. The decoding apparatus includes a fifth storage unit 1510, a sixth storage unit 1520, an obtaining unit 1530, a processing unit 1540, and a decoding unit 1550. The fifth storage unit 1510 is configured to store waveform data, and the sixth storage unit 1520 is configured to store spectral data. The fifth storage unit 1510 and the sixth storage unit 1520 are located in a lossless decoder on the decoding apparatus.

The obtaining unit 1530 is configured to: obtain a spectrum of the current frame Tᵢ, and update the spectrum of the current frame Tᵢ to the sixth storage unit. The processing unit 1540 is configured to perform integer inverse modified discrete cosine transform INTIMDCT on a spectrum in a storage unit on the lossless decoder to obtain a fourth transform result. The obtaining unit 1530 is further configured to obtain an overlapped frame of a previous frame Tᵢ₋₁. The processing unit 1540 is further configured to perform overlap-add OLA on the overlapped frame of the previous frame Tᵢ₋₁ and a non-aliased waveform in the fourth transform result to obtain a waveform of the current frame Tᵢ, where the spectrum of the previous frame Tᵢ₋₁ is decoded by a lossy decoder in the decoding apparatus.

The processing unit 1540 is further configured to initialize the fifth storage unit before performing integer inverse modified discrete cosine transform INTIMDCT on the spectrum in the storage unit on the lossless decoder.

The spectrum of the current frame Tᵢincludes N data points in frequency domain, and N is a positive integer; and the non-aliased waveform in the fourth transform result includes N non-aliased data points in time domain.

In an embodiment, the fourth transform result further includes N/2 aliased data points in time domain, and the processing unit 1540 is further configured to update the N/2 aliased data points in time domain to the fifth storage unit 1510.

The decoding unit 1550 is configured to perform decoding and dequantization processing on a received encoded bitstream, where the spectrum of the current frame Tᵢ is obtained from a processing result.

Specifically, for a specific process of each operation of the decoding apparatus in the foregoing embodiment in FIG. 15, correspondingly refer to the foregoing method embodiment for switching from the lossy decoder to the lossless decoder (that is, the embodiment in FIG. 9 and FIG. 10), and details are not described herein again.

FIG. 16 is a diagram of a structure of a decoding apparatus according to an embodiment of this application. The decoding apparatus includes a seventh storage unit 1610, an eighth storage unit 1620, a ninth storage unit 1660, an obtaining unit 1630, a processing unit 1640, and a decoding unit 1650. The seventh storage unit 1610 is configured to store spectral data, the eighth storage unit 1620 is configured to store waveform data, and the ninth storage unit 1660 is configured to store spectral data. The seventh storage unit 1610 and the eighth storage unit 1620 are located in a lossy decoder on the decoding apparatus, and the ninth storage unit 1660 is located in a lossless decoder on the decoding apparatus.

The obtaining unit 1630 is configured to: obtain a spectrum of a current frame Tᵢ, and update the spectrum of the current frame Tᵢ to the seventh storage unit. The processing unit 1640 is configured to perform inverse modified discrete cosine transform IMDCT on the data in the storage unit on the lossy decoder to obtain a fifth transform result. The processing unit 1640 is further configured to perform inverse integer window time domain aliasing cancellation Inverse INT winTDAC on an overlapped frame of a previous frame Tᵢ₋₁ in a storage unit on the lossless decoder to obtain a sixth transform result, where a spectrum of the previous frame Tᵢ₋₁ is decoded by the lossless decoder. The processing unit 1640 is further configured to perform overlap-add OLA on a non-aliased waveform in the sixth transform result and a corresponding waveform in the fifth transform result, to obtain a waveform of the current frame Tᵢ.

The processing unit 1640 is further configured to update an overlapped frame of the current frame Tᵢ in the fifth transform result to the eighth storage unit.

The fifth transform result includes the overlapped frame of the current frame Tᵢ and a time domain non-aliased waveform corresponding to the current frame Tᵢ. The time domain non-aliased waveform corresponding to the current frame Tᵢ corresponds to the non-aliased waveform in the sixth transform result.

The processing unit 1640 is further configured to initialize the eighth storage unit before performing inverse modified discrete cosine transform IMDCT on the data in the storage unit on the lossy decoder.

The processing unit 1640 is further configured to initialize the ninth storage unit in the storage unit on the lossless decoder before performing inverse integer window time domain aliasing cancellation Inverse INT winTDAC on the overlapped frame of the previous frame Tᵢ₋₁ in the storage unit on the lossless decoder, where the ninth storage unit is configured to store the spectral data.

The decoding unit 1650 is configured to perform decoding and dequantization processing on a received encoded bitstream, where the spectrum of the current frame Tᵢ is obtained from a processing result.

Specifically, for a specific process of each operation of the decoding apparatus in the foregoing embodiment in FIG. 16, correspondingly refer to the foregoing method embodiment for switching from the lossless decoder to the lossy decoder (that is, the embodiment in FIG. 11 and FIG. 12), and details are not described herein again.

An embodiment of this application provides an encoder. The encoder includes a processing circuit and an interface circuit. The processing circuit and the interface circuit are interconnected through a line. The interface circuit is configured to send an encoded bitstream of an audio frame, and the processing circuit may be configured to perform the method embodiments in FIG. 5 to FIG. 8.

An embodiment of this application provides a decoder. The decoder includes a processing circuit and an interface circuit. The processing circuit and the interface circuit are interconnected through a line. The interface circuit is configured to receive an encoded bitstream of an audio frame, and the processing circuit may be configured to perform the method embodiments in FIG. 9 to FIG. 12.

An embodiment of this application provides an encoder, including one or more processors and a non-transitory computer-readable storage medium. The non-transitory computer-readable storage medium is coupled to the processor and stores a program executed by the processor. When the program is executed by the processor, the encoder is enabled to perform the method embodiments in FIG. 5 to FIG. 8 (that is, the methods for switching between the lossy encoder and the lossless encoder).

An embodiment of this application provides a decoder, including one or more processors and a non-transitory computer-readable storage medium. The non-transitory computer-readable storage medium is coupled to the processor and stores a program executed by the processor. When the program is executed by the processor, the decoder is enabled to perform the method embodiments in FIG. 9 to FIG. 12 (that is, the methods for switching between the lossy decoder and the lossless decoder).

An embodiment of this application provides a non-transitory computer-readable storage medium, including program code. When the program code is executed by a computer device, the program code is configured to perform the methods in the method embodiments in FIG. 5 to FIG. 12.

An embodiment of this application provides a computer program product, including program code. When the program code is executed on a computer or a processor, the program code is configured to perform the methods in the method embodiments in FIG. 5 to FIG. 12.

In the foregoing embodiments, the description of each embodiment has respective focuses. For a part that is not described in detail in an embodiment, refer to the related descriptions in other embodiments. It should be noted that, for brief description, the foregoing method embodiments are represented as a series of action combinations. However, a person skilled in the art should understand that this application is not limited to the described action sequence, because some operations may be performed in other sequences or simultaneously according to this application. It should be further appreciated by a person skilled in the art that embodiments described in this specification all belong to example embodiments, and the related actions and modules are not necessarily required by this application.

In the several embodiments provided in this application, it should be understood that the disclosed apparatus may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The foregoing units described as separate parts may or may not be physically separate, and parts displayed as units may or may not be physical units, may be located in one position, or may be distributed on a plurality of network units. Some or all of the units may be selected according to actual requirements to achieve the objectives of the solutions of embodiments.

The foregoing embodiments are merely intended for describing the technical solutions of this application other than limiting this application. Although this application is described in detail with reference to the foregoing embodiments, a person of ordinary skill in the art should understand that they may still make modifications to the technical solutions described in the foregoing embodiments or make equivalent replacements to some technical features thereof, without departing from the scope of the technical solutions of embodiments of this application.

What is claimed is:

1. A method for switching from a lossy encoder to a lossless encoder, comprising:
obtaining a waveform of a previous frame Tᵢ₋₁, and updating the waveform of the previous frame Tᵢ₋₁ to an input frame buffer, wherein the waveform of the previous frame Tᵢ₋₁ is encoded by the lossy encoder, wherein a lossless encoder buffer comprises an overlapped buffer and the input frame buffer, the overlapped buffer is configured to store an aliased waveform, and the input frame buffer is configured to store a non-aliased waveform;
performing integer window time domain aliasing cancellation (INT winTDAC) on the waveform in the lossless encoder buffer to obtain a first transform result, and updating the first transform result to the overlapped buffer;
obtaining a waveform of a current frame Tᵢ, and updating the waveform of the current frame Tᵢ to the input frame buffer; and
performing integer modified discrete cosine transform (INTMDCT) on the waveform in the lossless encoder buffer to obtain a second transform result.

2. The method according to claim 1, wherein the method further comprises:
initializing the overlapped buffer before INT winTDAC is performed on the waveform in the lossless encoder buffer.

3. The method according to claim 1, wherein
both the waveform of the previous frame Tᵢ₋₁ and the waveform of the current frame Tᵢ comprise N non-aliased data points in time domain, and N is a positive integer;
the first transform result comprises N/2 aliased data points in time domain; and
the second transform result comprises N/2 aliased data points in time domain and N data points in frequency domain.

4. The method according to claim 3, wherein the method further comprises:
updating, to the overlapped buffer, the N/2 aliased data points in time domain in the second transform result.

5. The method according to claim 3, wherein the method further comprises:
quantizing and encoding the N data points in frequency domain in the second transform result to obtain an encoded bitstream corresponding to the current frame Tᵢ.

6. The method according to claim 1, wherein the waveform of the previous frame Tᵢ₋₁ is obtained from the lossless encoder buffer, and the waveform of the current frame Tᵢ is obtained from pulse-code modulation (PCM) audio data.

7. A method for switching from a lossless encoder to a lossy encoder, comprising:
obtaining a waveform of a previous frame Tᵢ₋₁, and updating the waveform of the previous frame Tᵢ₋₁ to a previous frame buffer, wherein the waveform of the previous frame Tᵢ₋₁ is encoded by the lossless encoder, wherein a lossy encoder buffer comprises the previous frame buffer and a current frame buffer, the previous frame buffer is configured to store the waveform of the previous frame Tᵢ₋₁, and the current frame buffer is configured to store a waveform of a current frame Tᵢ;
obtaining a waveform of the current frame Tᵢ, and updating the waveform of the current frame Tᵢ to the current frame buffer; and
performing modified discrete cosine transform (MDCT) on the waveform in the lossy encoder buffer to obtain a third transform result.

8. The method according to claim 7, wherein
both the waveform of the previous frame Tᵢ₋₁ and the waveform of the current frame Tᵢ comprise N non-aliased data points in time domain, and N is a positive integer; and
the third transform result comprises N data points in frequency domain.

9. The method according to claim 7, wherein the method further comprises:
quantizing and encoding the third transform result to obtain an encoded bitstream corresponding to the current frame Tᵢ.

10. A method for switching from a lossy decoder to a lossless decoder, comprising:
obtaining a spectrum of a current frame Tᵢ, and updating the spectrum of the current frame Tᵢ to an input frame buffer, wherein a lossless decoder buffer comprises an overlapped buffer and the input frame buffer, the overlapped buffer is configured to store waveform data, and the input frame buffer is configured to store spectral data;
performing integer inverse modified discrete cosine transform (INTIMDCT) on a spectrum in the lossless decoder buffer to obtain a fourth transform result; and
obtaining an overlapped frame of a previous frame Tᵢ₋₁, and performing overlap-add (OLA) on the overlapped frame of the previous frame Tᵢ₋₁ and a non-aliased waveform in the fourth transform result to obtain a waveform of the current frame Tᵢ, wherein the spectrum of the previous frame Tᵢ₋₁ is decoded by the lossy decoder.

11. The method according to claim 10, wherein the method further comprises:
initializing the overlapped buffer before INTIMDCT is performed on the spectrum in the lossless decoder buffer.

12. The method according to claim 10, wherein
the spectrum of the current frame Tᵢ comprises N data points in frequency domain, and N is a positive integer; and
the non-aliased waveform in the fourth transform result comprises N non-aliased data points in time domain.

13. The method according to claim 10, wherein the fourth transform result further comprises N/2 aliased data points in time domain, and the method further comprises:
updating, to the overlapped buffer, the N/2 aliased data points in time domain.

14. The method according to claim 10, wherein obtaining the spectrum of the current frame Tᵢ comprises:
performing, by the lossless decoder, decoding and dequantization processing on a received encoded bitstream, and obtaining the spectrum of the current frame Tᵢ from a processing result.

15. A method for switching from a lossless decoder to a lossy decoder, comprising:
obtaining a spectrum of a current frame Tᵢ, and updating the spectrum of the current frame Tᵢ to a current frame buffer, wherein a lossy decoder buffer comprises the current frame buffer, and the current frame buffer is configured to store spectral data;
performing inverse modified discrete cosine transform (IMDCT) on the data in the lossy decoder buffer to obtain a fifth transform result;
performing inverse integer window time domain aliasing cancellation (Inverse INT winTDAC) on an overlapped frame of a previous frame Tᵢ₋₁ in a lossless decoder buffer to obtain a sixth transform result, wherein a spectrum of the previous frame Tᵢ₋₁ is decoded by the lossless decoder; and
performing overlap-add (OLA) on a non-aliased waveform in the sixth transform result and a corresponding waveform in the fifth transform result to obtain a waveform of the current frame Tᵢ.

16. The method according to claim 15, wherein the lossy decoder buffer further comprises a next frame buffer, and the next frame buffer is configured to store waveform data; and the method further comprises:
updating an overlapped frame of the current frame Tᵢ in the fifth transform result to the next frame buffer.

17. The method according to claim 16, wherein
the fifth transform result comprises the overlapped frame of the current frame Tᵢ and a time domain non-aliased waveform corresponding to the current frame Tᵢ; and
the time domain non-aliased waveform corresponding to the current frame Tᵢ corresponds to the non-aliased waveform in the sixth transform result.

18. The method according to claim 15, wherein the method further comprises:
initializing a next frame buffer before inverse modified discrete cosine transform IMDCT is performed on the data in the lossy decoder buffer.

19. The method according to claim 15, wherein the method further comprises:
initializing an input frame buffer in the lossless decoder buffer before inverse integer window time domain aliasing cancellation (Inverse INT winTDAC) is performed on the overlapped frame of the previous frame Tᵢ₋₁ in the lossless decoder buffer, wherein the input frame buffer is configured to store spectral data.

20. The method according to claim 15, wherein obtaining the spectrum of the current frame Tᵢ comprises:
performing, by the lossy decoder, decoding and dequantization processing on a received encoded bitstream, and obtaining the spectrum of the current frame Tᵢ from a processing result.
